(19) United States
(12) Patent Application Publication
(10) Pub. No.: US 2026/0022856 A1
(43) Pub. Date: Jan. 22, 2026

(54) SMART HOME DEVICE FEATURE SET SELECTION BASED ON POWER SOURCE AVAILABILITY

(71) Applicant: Google LLC, Mountain View, CA (US)

(72) Inventors: Bhaveya Dhall, San Francisco, CA (US); Michael Mitchell, San Francisco, CA (US)

(73) Assignee: Google LLC, Mountain View, CA (US)

(21) Appl. No.: 18/774,673

(22) Filed: Jul. 16, 2024

(51) Int. Cl. F24F 11/88; F24F 11/52; F24F 120/12; H02J 3/00

(52) U.S. Cl. CPC F24F 11/88; F24F 11/52; H02J 3/00; F24F 2120/12

(57) ABSTRACT

Feature sets of smart home devices may be activated based on whether they can be supported by a selected power sourcing method. For example, thermostats may use a technique known as “power stealing” in order to steal power from the HVAC system. Different algorithms and techniques may be used for efficiently stealing power from the HVAC system, each of which may provide different levels of power to the thermostat at different times. The smart home device may test an external system to determine which power stealing methods are compatible, then select predetermined feature sets that are compatible with the available power stealing methods.

### TECHNICAL FIELD

This disclosure generally describes methods of powering smart home devices. More specifically, this disclosure describes using a selection of a power stealing algorithm to selectively activate features on the smart home device.

### BACKGROUND

Smart home devices are continually trending towards low-power designs while still providing rich feature sets and complex algorithmic operations. The smart home devices may include environmental control devices, hazard detectors, security systems, cameras, doorbells, and so forth. For example, smart thermostats may provide control of air handling systems, such as heating, ventilation, and air conditioning (HVAC) systems. In such systems, control of the air handling is often effectuated based on an end user's interactions with a control application that is executing on the end user's electronic device. Cloud-based servers often facilitate communication between these electronic devices and the air handling systems. While remote control of air handling systems is convenient, it may be desirable to provide a feature-rich means to effectuate local control of these air handling systems. Control devices, such as thermostats, may include a variety of sensors that may be used for monitoring environmental conditions within the home.

However, as smart home devices become more complex and become more integrated into the smart home environment, these devices are often tasked with performing many high-power functionalities. These functionalities may include Wi-Fi communication routing, occupancy detection, complex displays, and learning algorithms that require extensive power consumption. At the same time, many smart home devices are powered by the systems which they control through a method known as “power stealing” in order to provide maximum compatibility existing homes. Power stealing may not be sufficient to power many high-power functionalities. Therefore, improvements are needed in this technology.

### SUMMARY

In some embodiments, a thermostat may include a power wire connector for controlling a heating, ventilation, and air conditioning (HVAC) function of an HVAC system, a return wire connector for the HVAC function, and one or more switching elements. The one or more switching elements may be configured to operate in a first operating state in which the one or more switching elements create a connection between the power wire connector and the return wire connector to activate the HVAC function, and in a second operating state in which the one or more switching elements interrupt the connection between the power wire connector and the return wire connector. The thermostat may also include one or more processors programmed to perform operations including controlling a timing of the one or more switching elements to steal power from the HVAC according to at least a first power-stealing method or a second power-stealing method; selecting a power stealing method from at least the first power-stealing method or the second power-stealing method based at least in part on a characteristic of the HVAC system; and selecting a set of functions from a plurality of functions of the thermostat to be active, wherein the set of functions are compatible with the power stealing method.

In some embodiments, a method may include accessing a selection of a power sourcing method for a smart home device from among a plurality of power sourcing methods that are compatible with the smart home device. The plurality of power sourcing methods may include sourcing power from an environmental system that is controlled by the smart home device. The method may also include, based on the selection of the power sourcing method, selecting a set of functions from a plurality of functions. The set of functions may be compatible with the selection of the power sourcing method. The method may additionally include powering the smart home device using the selection of the power sourcing method and operating the smart home device to perform the set of functions that are compatible with the power sourcing method.

In some embodiments, a smart home device may include one or more wire connectors configured to receive wires from an external system, where the smart home device is configured to control the external system. The smart home device may also include one or more processors configured to perform operations including accessing a selection of a power sourcing method for a smart home device from among a plurality of power sourcing methods that are compatible with the smart home device. The plurality of power sourcing methods may include sourcing power from the external system that is controlled by the smart home device. The operations may also include, based on the selection of the power sourcing method, selecting a set of functions from a plurality of functions of the smart home device. The set of functions may be compatible with the selection of the power sourcing method. The operations may further include powering the smart home device using the selection of the power sourcing method and operating the smart home device to perform the set of functions that are compatible with the power sourcing method.

In any embodiments, any and all of the following features may be implemented in any combination and without limitation. The set of functions may include edge routing between a local Wi-Fi network and a Thread network, where the edge routing may be enabled when the first power-stealing method is selected and disabled when the second power-stealing method is selected. The set of functions may include waking a display of the thermostat when a user approach is detected, where the waking of the display may be enabled when the first power-stealing method is selected and disabled when the second power-stealing method is selected. The set of functions may include using a radar sensor to detect human occupancy, where using the radar sensor may be enabled when the first power-stealing method is selected and disabled when the second power-stealing method is selected. The set of functions may include a wireless transmission rate, where a first wireless transmission rate may be enabled when the first power-stealing method is selected, and a second wireless transmission rate may be enabled when the second power-stealing method is selected, and the first wireless transmission rate may be greater than the second wireless transmission rate. The first power-stealing method may include a timing of the one or more switching elements that is phase-aware of a zero-crossing of a current waveform through the one or more switching elements. The second power-stealing method may include a timing of the one or more switching elements that is not based on a phase of a current waveform through the one or more switching elements. The plurality of power sourcing methods may include sourcing power from a dedicated power line from the environmental system. The dedicated power line from the environmental system may include a C wire from an HVAC system. The smart home device may include a thermostat. The smart home device may include a smart doorbell. The method/operations may also include selecting a power sourcing method that is capable of sourcing power from the external system without interrupting and operation of the external system. The method/operations may also include selecting the power sourcing comprises using a test load on an output of a power converter in the smart home device. Selecting the power sourcing method may further include measuring a voltage at an input of the power converter as the test load is increased. Selecting the power sourcing method may further include estimating an impedance of the external system based on a rate at which the voltage at the input of the power converter drops per increase of the test load. Selecting the power sourcing method may further include comparing the impedance to a threshold to select the power sourcing method. The method/operations may also include monitoring a voltage drop on a storage capacitor to determine whether the selection of the power sourcing method should be used.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram of an embodiment of a smart thermostat system.

FIG. 2A is an isometric view of an embodiment of a smart thermostat.

FIG. 2B is a front view of an embodiment of smart thermostat.

FIG. 2C is a side view of an embodiment of a smart thermostat.

FIG. 3 is an exploded front isometric view of an embodiment of smart thermostat.

FIG. 4 is an exploded rear isometric view of smart thermostat.

FIG. 5A illustrates a front view of a smart thermostat backplate.

FIG. 5B illustrates a side view of a smart thermostat backplate.

FIG. 5C is an exploded front isometric view of the smart thermostat backplate.

FIG. 6 is an exploded front view of various embodiments of lens assembly.

FIG. 7 is a cross section of an embodiment of smart thermostat.

FIG. 8 is an enlarged cross section of a side view of a smart thermostat.

FIG. 9 is clip for use with a smart thermostat.

FIG. 10 is an isometric cross section of a side view of a smart thermostat.

FIG. 11 illustrates a flowchart of a method for selecting feature sets based on power sourcing methods, according to some embodiments.

FIG. 12 illustrates a power management and power stealing system for a smart thermostat, according to some embodiments.

FIG. 13 illustrates a typical modern HVAC system, according to some embodiments.

FIG. 14 illustrates a contactor and the associated current waveforms used to activate the contactor, according to some embodiments.

FIG. 15 illustrates a graph of waveforms present in the contactor of the air conditioning system and the switch of the thermostat, according to some embodiments.

FIG. 16 illustrates a flowchart of a method for testing different power stealing methods, according to some embodiments.

FIG. 17 illustrates a flowchart of a method for selecting a feature set based on a selected power sourcing method, according to some embodiments.

FIG. 18 illustrates an example smart home environment.

### DETAILED DESCRIPTION

The techniques and systems described herein are compatible with many different smart home devices. However, in order to provide an enabling disclosure and at least one example of a smart home device, the following disclosure will describe a smart thermostat in detail. Additionally, the techniques and systems described below for powering a smart home device and selecting feature sets that are compatible with a particular power sourcing method are described using a thermostat as an example. However, it should be understood that these techniques and systems may also be applied to other smart home devices without limitation, including cameras, security systems, hazard detectors, door entry/doorbell systems, child monitoring systems, intercom systems, and so forth.

Thermostats that communicate via a network and allow end users to interact with a heating, ventilation, and air conditioning system (referred to herein as “HVAC system,” “HVAC systems,” “air handling system,” and “air management system”) from remote locations have become prevalent. Typically, an end user will use a control application that is executing on an electronic device such as a mobile phone to connect with and operate the thermostat and/or HVAC system. Such thermostats often include advanced features such as Internet or Wi-Fi connectivity, occupancy detection, home/away/vacation modes, indoor climate sensing, outdoor climate sensing, notifications, display of current weather conditions, learning modes, and others. Thermostats such as the foregoing and others can be referred to as smart thermostats.)

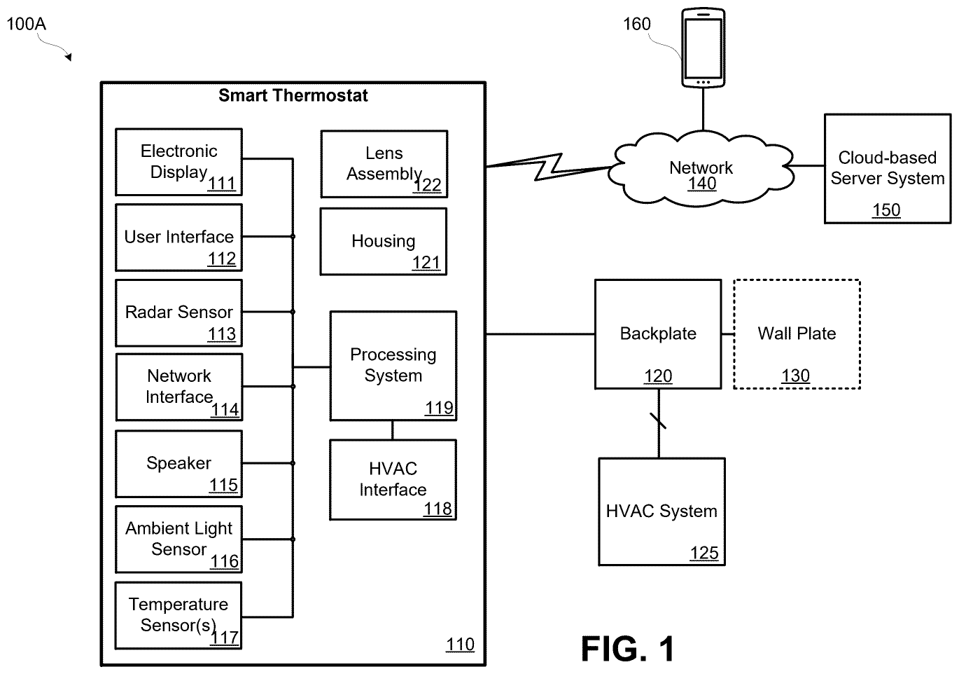

FIG. 1 is a block diagram of an embodiment of a smart thermostat system. Smart thermostat system 100A can include smart thermostat 110; backplate 120; HVAC system 12; wall plate 130; network 140; cloud-based server system 150; and computerized device 160. Smart thermostat 110 represents embodiments of thermostats detailed herein. Smart thermostat 110 can include: electronic display 111; user interface 112; radar sensor 113; network interface 114; speaker 115; ambient light sensor 116; one or more temperature sensors 117; HVAC interface 118; processing system 119; housing 121; and lens assembly 122.

Electronic display 111 may be visible through the lens assembly 122. In some embodiments, electronic display 111 is only visible when electronic display 111 is at least partially illuminated. In some embodiments, electronic display 111 is not a touch screen which can allow the electronic display 111 to serve as a user interface to receive input. If a touch sensor, the electronic display 111 may allow one or more gestures, including tap and swipe gestures, to be detected.

User interface 112 can be various forms of input devices through which a user can provide input to smart thermostat 110. In some embodiments herein, an outer rotatable ring is present as part of user interface 112. The ring can be rotated by a user clockwise and counterclockwise in order to provide input. The ring can be infinitely rotatable in either direction, thus allowing a user to scroll or otherwise navigate user interface menus. The ring (and, possibly, lens assembly 122) can be pressed inward (toward the rear of smart thermostat 110) to function as a “click” or to make a selection. The outer rotatable ring can, for example, allow the user to make temperature target adjustments. By rotating the outer ring clockwise, the target temperature can be increased, and by rotating the outer ring counterclockwise, the target temperature can be decreased. As another example, the ring can be rotated to highlight displayed icons; an inward click can be provided by a user to select a particular icon.

Radar sensor 113 may be a single integrated circuit (IC) that can emit radio waves, receive reflected radio waves, and output radar data indicative of the received reflected radio waves. Radar sensor 113 may be configured to output radio waves into the ambient environment in front of electronic display 111 of the smart thermostat 110. The radar sensor 113 may emit radio waves and receive reflected radio waves through the lens assembly 122. The radar sensor 113 may include one or more antennas, one or more radio frequency (RF) emitters, and one or more RF receivers. The radar sensor 113 may be configured to operate as frequency-modulated continuous wave (FMCW) radar. The radar sensor 113 may emit chirps of radar that sweep from a first frequency to a second frequency (e.g., in the form of a saw tooth waveform). Using receive-side beam-steering (e.g., using multiple receiving antennas), certain regions may be targeted for sensing the presence of objects and/or people. The output of the radar sensor 113, which can be a radar data stream, may be analyzed using the processing system 119. The radar sensor 113 and the processing system 119 may be referred to hereinafter as radar subsystem.

Network interface 114 may be used to communicate with one or more wired or wireless networks. Network interface 114 may communicate with a wireless local area network, such as a Wi-Fi network. Additional or alternative network interfaces may also be present. For example, smart thermostat 110 may be able to communicate with a user device directly, such as using Bluetooth or some other device-to-device short-range wireless communication protocol. Smart thermostat 110 may be able to communicate via a mesh network with various other home automation devices such as using Thread or Matter. Mesh networks may use relatively less power compared to wireless local area network-based communication, such as Wi-Fi. In some embodiments, smart thermostat 110 can serve as an edge router that translates communications between a mesh network and a wireless local area network, such as a Wi-Fi network. In some embodiments, a wired network interface may be present, such as to allow communication with a local area network (LAN). One or more direct wireless communication interfaces may also be present, such as to enable direct communication with a remote temperature sensor installed in a different housing external and distinct from housing 121. The evolution of wireless communication to fifth generation (5G) and sixth generation (6G) standards and technologies provides greater throughput with lower latency which enhances mobile broadband services. 5G and 6G technologies also provide new classes of services, over control and data channels, for vehicular networking (V2X), fixed wireless broadband, and the Internet of Things (IoT). Smart thermostat 110 may include one or more wireless interfaces that can communicate using 5G and/or 6G networks.

Speaker 115 can be used to output audio. Speaker 115 may be used to output beeps, clicks, synthesized speech, or other audible sounds, such as in response to the detection of user input via user interface 112.

Ambient light sensor 116 may sense the amount of light present in the environment of smart thermostat 110. Measurements made by ambient light sensor 116 may be used to adjust the brightness of electronic display 111. In some embodiments, ambient light sensor 116 senses an amount of ambient light through lens assembly 122. Therefore, compensation for the reflectivity of lens assembly 122 may be made such that the ambient light levels are correctly determined via ambient light sensor 116. In some implementations, a light pipe is present between ambient light sensor 116 and lens assembly 122 such that, in a particular region of lens assembly 122, light that is transmitted through lens assembly 122, is directed to ambient light sensor 116, which may be mounted to a printed circuit board (PCB), such as a PCB to which processing system 119 is attached.

One or more temperature sensors 117, may be present within smart thermostat 110.

The one or more temperature sensors 117 may be used to measure the ambient temperature in the environment of smart thermostat 110. One or more additional temperature sensors that are remote from smart thermostat 110 may additionally or alternatively be used to measure the temperature of the ambient environment.

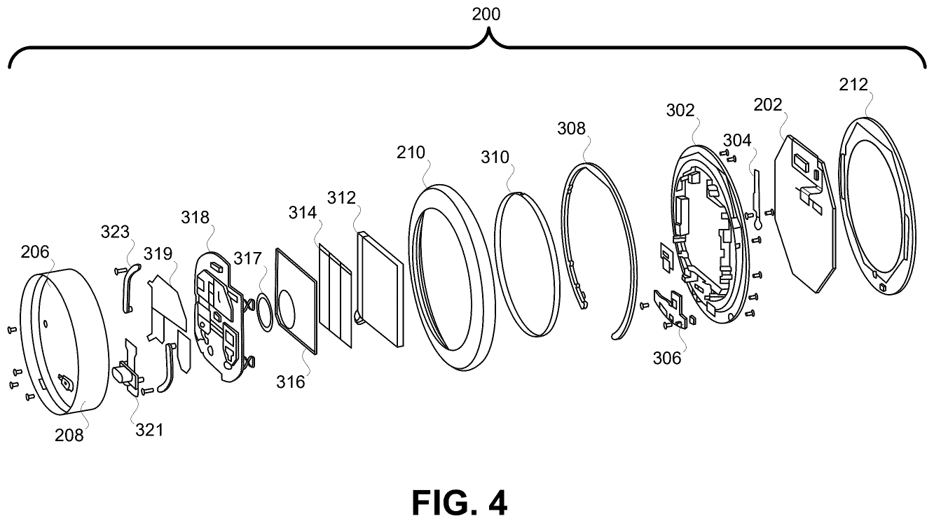

Lens assembly 122 may have a transmissivity sufficient to allow illuminated portions of electronic display 111 to be viewed through lens assembly 122 from an exterior of smart thermostat 110 by a user. Lens assembly 122 may have a reflectivity sufficient such that portions of lens assembly 122 that are not illuminated from behind appear to have a mirrored effect to a user viewing a front of smart thermostat 110. Further detail regarding the lens assembly 122 are provided in relation to FIGS. 4-7.

HVAC interface 118 can include one or more interfaces that control whether a circuit involving various HVAC control wires that are connected either directly with smart thermostat 110 or with backplate 120 is completed. A heating system (e.g., furnace, boiler, heat pump), cooling system (e.g., air conditioner, heat pump), fan, or some combination thereof may be controlled via HVAC wires by opening and closing circuits that include the HVAC control wires. In some installations, one a heating system or cooling system is controlled by the smart thermostat 110; in other embodiments, the smart thermostat 110 may control both a heating system and a cooling system.

Processing system 119 can include one or more processors. Processing system 119 may include one or more special-purpose or general-purpose processors. Such special-purpose processors may include processors that are specifically designed to perform the functions detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD) of smart thermostat 110.

Processing system 119 may output information for presentation to electronic display 111. Processing system 119 can receive information from the one or more temperature sensors 117, user interface 112, radar sensor 113, network interface 114, and ambient light sensor 116. Processing system 119 can perform bidirectional communication with network interface 114. Processing system 119 can output information to be output as sound to speaker 115. Processing system 119 can control the HVAC system 125 via HVAC interface 118.

Housing 121 may house and/or attach with all of the components of smart thermostat 110, either directly or via other components. For example, lens assembly 122 may adhere to the electronic display 111, which is attached with housing 121.

The smart thermostat 110 may be attached (and removed) from backplate 120. Some number of HVAC control wires may be attached with terminals or receptacles of backplate 120. Such HVAC control wires electrically connect backplate 120 with the HVAC system 125, which can include a heating system, cooling system, ventilation system, or some combination thereof. Backplate 120 can allow the smart thermostat 110 to be attached and removed from backplate 120 without affecting the electronic connections of the HVAC control wires with backplate 120. In other embodiments, such control wires are directly connected with smart thermostat 110. In some embodiments, wall plate 130 may additionally be installed between backplate 120 and a surface, such as a wall, such as for aesthetic reasons (e.g., cover an unsightly hole through which HVAC wires protrude from the wall).

Network 140 can include one or more wireless networks, wired networks, public networks, private networks, and/or mesh networks. A home wireless local area network (e.g., a Wi-Fi network) may be part of network 140. Network 140 can include the Internet. Network 140 can include a mesh network, which may include one or more other smart home devices, may be used to enable smart thermostat 110 to communicate with another network, such as a Wi-Fi network. Smart thermostat 110 may function as an edge router that translates communications from a relatively low power mesh network received from other devices to another form of network, such as a relatively higher power network, such as a Wi-Fi network.

Cloud-based server system 150 can maintain an account mapped to smart thermostat 110. Smart thermostat 110 may periodically or intermittently communicate with cloud-based server system 150 to determine whether setpoint or schedule changes have been made. A user may interact with smart thermostat 110 via computerized device 160, which may be a mobile device, smartphone, tablet computer, laptop computer, desktop computer, or some other form of computerized device that can communicate with cloud-based server system 150 via network 140 or can communicate directly with smart thermostat 110 (e.g., via Bluetooth or some other device-to-device communication protocol). A user can interact with an application executed on computerized device 160 to control or interact with smart thermostat 110.

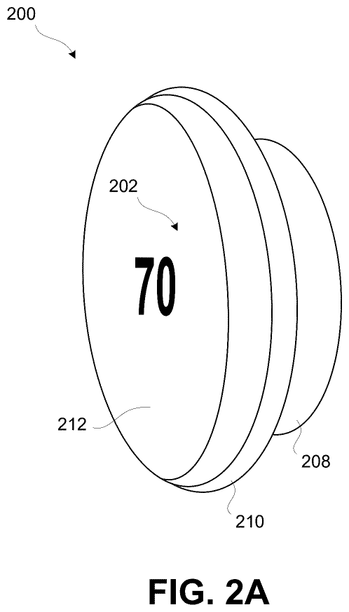

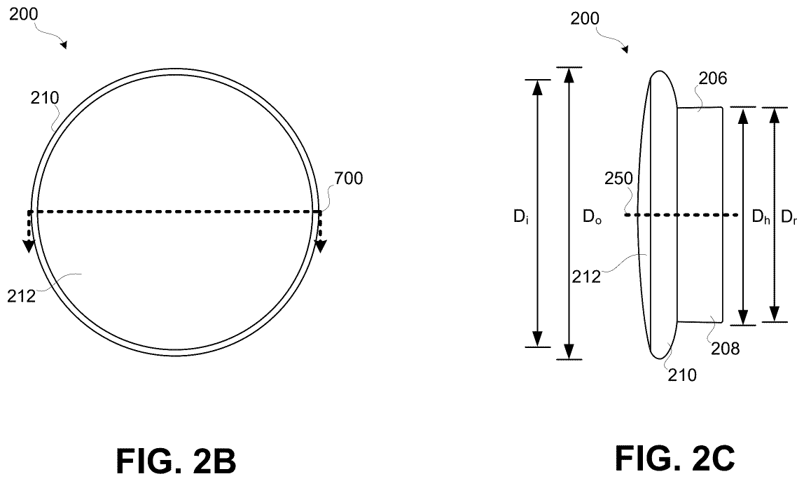

FIG. 2A is an isometric view of an embodiment of a smart thermostat 200. Smart thermostat 200 can represent an embodiment of smart thermostat 110 of FIG. 1. In FIG. 2A, electronic display 202, located behind lens assembly 212, is active in displaying a setpoint temperature. The housing of smart thermostat 200 can define sidewall 208. Sidewall 208 may be generally cylindrical according to various embodiments. A diameter of the sidewall 208 may be smaller than a diameter of the electronic display 202 and ring 210 according to various embodiments and as illustrated in FIG. 2A. Ring 210 can function as detailed in relation to user interface 112. Either attached with housing 121 or attached with components connected with housing 121 is lens assembly 212. Lens assembly 212 may include a reflective layer having a reflectivity such that when the electronic display 202 is not illuminated, lens assembly 212 appears to be a mirror when viewed by a user.

In some embodiments, ring 210 is mounted to lens assembly 212. In other embodiments, ring 210 can be rotated clockwise and counterclockwise independent of lens assembly 212. In some embodiments, housing 121 includes a display frame (not visible in this view) that further supports electronic display 202 and lens assembly 212.

Electronic display 202 is housed behind lens assembly 212 such that, when illuminated, the portion of electronic display 202 that is illuminated is visible through lens assembly 212 by a user. In some embodiments, due to the reflectivity of lens assembly 212, an edge of electronic display 202 is not visible to a user regardless of whether electronic display 202 is illuminated, partially illuminated, or not illuminated. Therefore, the overall effect experienced by a user may be that lens assembly 212 appears as a mirror and portions of electronic display 202, when illuminated, are visible through lens assembly 212.

In various embodiments, around an axis perpendicular to the display face of electronic display 202, the ring 210 has an inner diameter and an outer diameter and both the inner diameter and the outer diameter of ring 210 are larger than a diameter of sidewall 208 of housing 121.

FIG. 2B is a front view of an embodiment of smart thermostat 200. When mounted on a wall or other surface, lens assembly 212 is opposite the portion of smart thermostat 200 that mounts to the wall or other surface. Therefore, when a user is facing mounted smart thermostat 200, lens assembly 212 is visible. Lens assembly 212 can form an uninterrupted circular surface with no gaps, holes, lens, or other discontinuities present on the outermost surface of lens assembly 212. Lens assembly 212 has sufficient transmissivity to allow light emitted by electronic display 202 located within housing 206 to be visible through lens assembly 212. Further, lens assembly 212 may have sufficient reflectivity such that a mirrored effect is present on portions of lens assembly 212 that are not currently being illuminated from behind by electronic display 202.

FIG. 2C is a side view of an embodiment of a smart thermostat. When smart thermostat 200 is mounted to a wall or other surface, sidewall 208 of housing 121 is visible. Around an axis 250, the ring 210 has an inner diameter Di and an outer diameter Do and both the inner diameter Di and the outer diameter Do of the ring 210 are larger than a diameter Dh of sidewall 208 of housing 121. According to various embodiments, sidewall 208 of housing 121 can be generally cylindrical and can have a consistent diameter along a length thereof. Alternatively, a diameter of sidewall 208 can increase as a distance from lens assembly 212 increase.

In some embodiments, ring 210 has a smallest diameter at the rearmost portion of ring 210. Dᵣ is indicative of the diameter of ring 210 where ring 210 meets sidewall 208. This arrangement can help facilitate a user's fingers reaching around ring 210, grasping ring 210, and rotating in either direction. In some embodiments, along axis 250, sidewall 208 may have a diameter of approximately Dᵣ wherein ring 210 and sidewall 208 meet. In some embodiments, the diameter of sidewall 208 can increase as the distance from ring 210 increases.

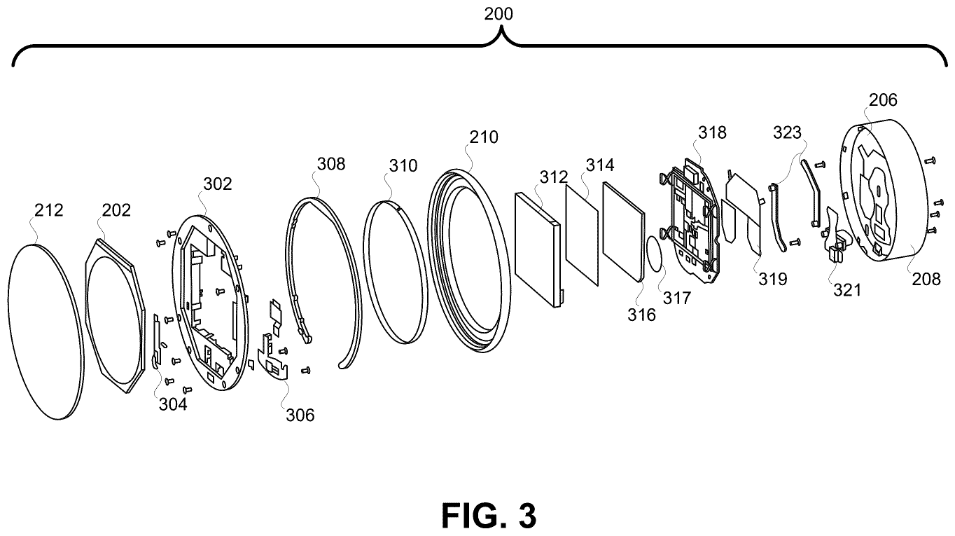

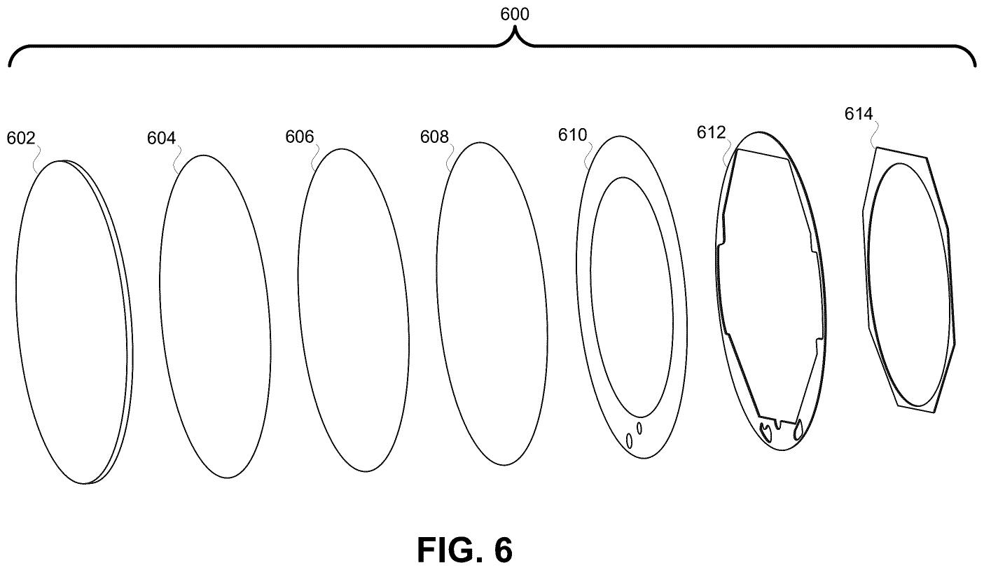

FIG. 3 is an exploded front isometric view of an embodiment of smart thermostat 200. FIG. 4 is an exploded rear isometric view of smart thermostat 200. Viewing the components of the smart thermostat 200 left to right, lens assembly 212 forms an outermost domed surface of smart thermostat 200. Adjacent lens assembly 212 may be electronic display 202. Electronic display 202 may be a liquid-crystal display (LCD) or organic light emitting diode (OLED) display according to various embodiments. In at least some embodiments, one or more adhesives may be used to attach electronic display 202 with lens assembly 212. An exploded view of lens assembly 212 is provided in relation to FIG. 6.

According to at least some embodiments, electronic display 202 is supported by a display frame 302. Smart thermostat 200 further includes one or more antenna assemblies 304 for communicating with a network and/or other electronic devices. Antenna assembly 304 can be used for communicating with wireless local area networks (e.g., Wi-Fi), device-to-device communication (e.g., Bluetooth), and/or communicating with mesh networks (e.g., Thread). Smart thermostat 200 includes one or more sensor boards, such as sensor daughterboard 306. One or more temperature sensors may be installed on sensor daughterboard 306. Use of sensor daughterboard 306 can help isolate the one or more temperature sensors from heat generated by other components.

Smart thermostat 200 may further include clip 308 for coupling ring 210 and display frame 302 supporting electronic display 202. Clip 308 may act as an axial constraint for smart thermostat 200. In particular, clip 308 prevents electronic display 202, display frame 302, and ring 210 from decoupling from one another in the assembled configuration.

As shown in FIGS. 3-4, smart thermostat can include magnetic strip 310. According to various embodiments, ring 210 rotates relative to sidewall 208 of housing 206 and a backplate when smart thermostat 200 is mounted to a surface. In various embodiments, a sensor installed on a sensor board, such as sensor board 306 and magnetic strip 310 are used for detecting rotation of the ring 210 during use.

According to various embodiments, ring 210 is mounted to housing 206 such that ring 210 can be rotated clockwise and counterclockwise. Ring 210 may include polished stainless steel and a finish applied using physical vapor deposition (PVD). Ring 210 further advantageously provides an aesthetic appearance as the finish of the ring 210 appears seamless relative to lens assembly 212 having a mirrored effect.

Further internal components of smart thermostat 200 include battery 312 and battery adhesive 314. Battery 312 can be a secondary battery and can provide power to the various components of smart thermostat 200, including electronic display 202 and processing system 119. Battery adhesive 314 may be used to adhere battery 312 within housing 206 although the battery 312 (or any other components of the smart thermostat 200) may be secured within the housing 206 using other means. For example, various components may be secured using adhesives, screws, wires, clips, or the like.

Smart thermostat 200 includes processing system 316. According to some embodiments, processing system 316 is a system-on-a-chip (SoC) including various processing parts, memory, modems, etc. Processing system 316 may be in electric communication with one or more antennas present on antenna assembly 304, sensor board 306, electronic display 202, etc., for performing various functions of the smart thermostat 200 and outputting results based on user input (e.g., in response to the user rotating the ring 210 and/or user input via an external mobile device). Adjacent processing system 316 may be piezo sensor 317. Additional components of the processing system 316 or components that work with processing system 316 are also shown in FIGS. 3-4. For example, multi-layer board (MLB) 318 may be provided for performing various functions of smart thermostat 200, in a manner that would be appreciated by one having ordinary skill in the art. In some embodiments, MLB 318 may include a Universal Serial Bus (USB) port for electrically coupling smart thermostat 200 to another electronic device for various updates, servicing, or the like. Various springs 319 for supporting components, flexes 321 for enabling flexible and high-density interconnects between printed circuit boards (PCBs), LCDs, etc., and additional links 323 may also be included in the internal components of smart thermostat 200.

Smart thermostat 200 may include more or fewer components than those shown in FIGS. 3-4. In various embodiments, the components may be in one or more configurations other than the configuration shown in FIGS. 3-4. Advantageously, various components of smart thermostat 200 are optimized to be condensed into housing 206 such that the overall side profile of smart thermostat 200 is significantly thinner than a side profile of other commercially available smart thermostats.

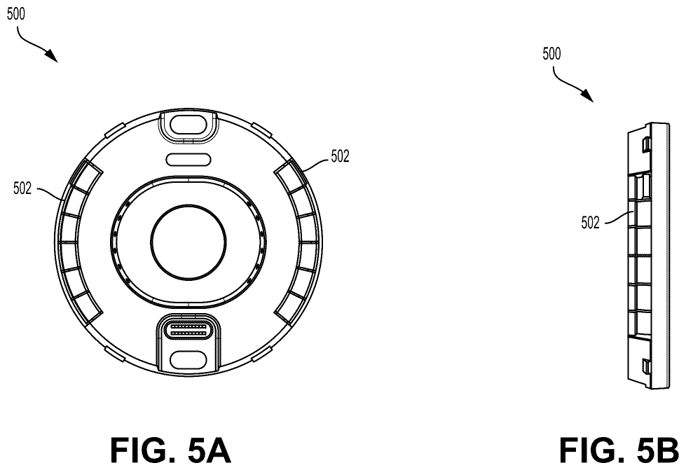

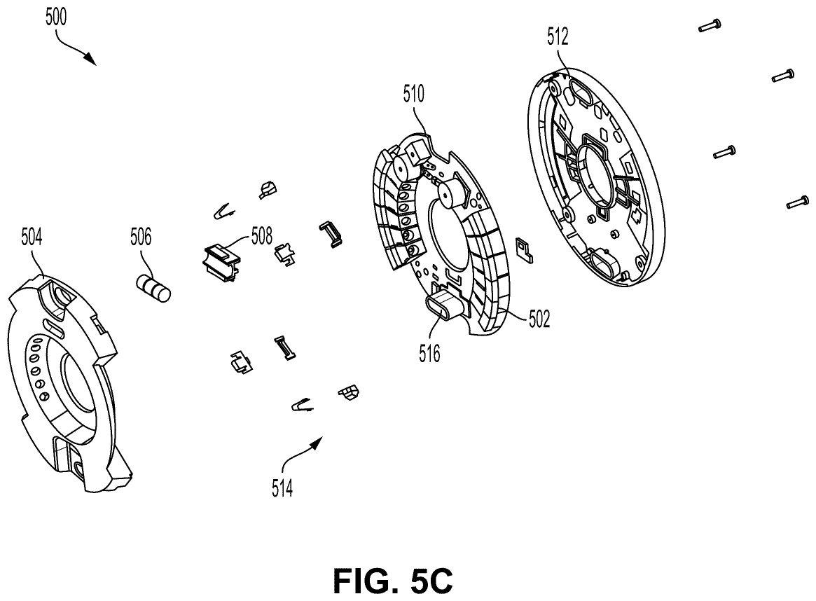

FIGS. 5A-5B illustrate a front view and a side view of a smart thermostat backplate. According to various embodiments, an electronic device, such as smart thermostat 200 described in detail above, may be mounted to a wall or other surface by a backplate 500. The backplate 500 may include a plurality of wire terminals 502 for receiving wires that are connected with a heating, ventilation, and cooling (HVAC) system. For example, the backplate 500 may include multiple receptacles, with each receptacle designated to receive a particular HVAC control wire. Backplate 500 can define one or more holes configured to receive fasteners or the like for securing backplate 500 and, if being used, a trim plate or the like, to a surface, such as a wall. The backplate 500 can removably attached with the thermostat housing, such as thermostat housing 206 described above.

In some embodiments, a smart thermostat may be attached (and removed) from backplate 500. HVAC control wires may be attached with terminals or receptacles of backplate 500. Alternatively, such control wires may be directly connected with the smart thermostat. In some embodiments, a trim plate may additionally be installed between the backplate 500 and a surface, such as a wall, such as for aesthetic reasons (e.g., cover an unsightly hole through which HVAC wires protrude from the wall).

FIG. 5C is an exploded front isometric view of the smart thermostat backplate of FIGS. 5A and 5B. Visible in this view, the backplate 500 includes a cap 504, a level 506, a level holder 508, and a coupling plate 510. Various components of the backplate 500 are coupled to one another with one or more fasteners 514. Fasteners 514 may be screws, nails, or some other form of fastener. Fasteners 514 can securely hold backplate 500 and, possibly, a trim plate (not shown) to a surface, such as a wall. A thermostat may removably attach with backplate 500. A user may be able to attach thermostat to backplate 500 by pushing thermostat against backplate 500. Similarly, a user can remove the thermostat from backplate 500 by pulling the thermostat away from backplate 500. When the thermostat is connected with backplate 500, the thermostat is electrically connected various HVAC control wires that have been connected with the receptacles of backplate 500 as would be appreciated by one having ordinary skill in the art.

Further visible in FIG. 5C, a cap 504 for protecting various internal components from damage and for providing an aesthetically pleasing appearance when the electronic device is not mounted to the backplate 500. The cap 504 covers a level 506 for properly mounting the electronic device and/or the backplate 500 to a surface. For example, it would be desirable to have text displayed on the electronic display of the smart thermostat to be straight across (e.g., perpendicular to the ground, etc.). The level 506 may be a bubble level in at least some embodiments. A level holder 508 may be provided to align the level 506 relative to the cap 504, a coupling plate 510, and a base 512. Additional coupling mechanisms may be provided including adhesives, screws, snaps, wires, or the like. The coupling plate 510 may include one or more fasteners as described in detail above. The coupling plate 510 may further include a board-to-board (BTB) connector 516 in some embodiments.

The backplate 500 may include more or less components than those shown in FIGS. 5A-5C. In various embodiments, the components may be in one or more configurations other than the configuration shown in FIGS. 5A-5C. For example, the backplate 500 may be part of a greater thermostat mounting system including a trim plate, batteries, various fasteners, sensors, or the like.

FIG. 6 is an exploded front view of various embodiments of lens assembly 600. Lens assembly 600 can represent embodiments of lens assembly 122 and 212. In particular, FIG. 6 illustrates an embodiment of a stack of components that can be used to create lens assembly 122. Lens assembly 600 can include: domed lens 602; optically clear adhesive (OCA) layer 604; tinted ink layer 606; mirror film 608; masking layer 610; frame pressure sensitive adhesive (PSA) 612; and display PSA 614. While embodiments of lens assembly 600 may be used on smart thermostat 200, embodiments of such a lens assembly may be used on other forms of smart devices. For instance, lens assembly 600 can be incorporated as part of a smart assistant device or a smart watch.

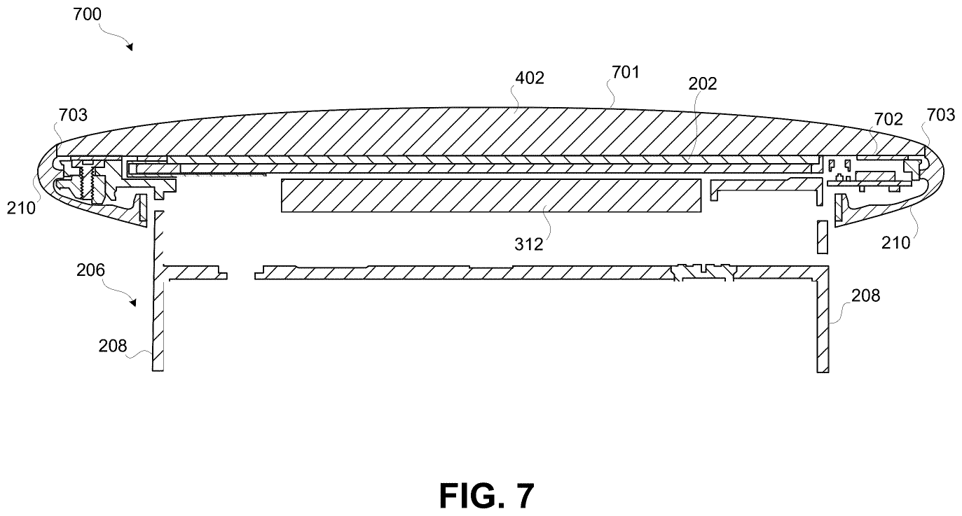

Domed lens 602 may be domed on an outer surface and flat on an inner surface that is in contact with OCA lay 604. Further detail regarding the shape of domed lens 602 is provided in reference to FIG. 7. Domed lens 602 can be formed from polymethyl methacrylate (PMMA), which can provide a transparency similar to glass. Other plastic or acrylic materials are also possible. Domed lens 602 may also be formed from glass. Domed lens 602 can be formed using injection compression molding. Injection compression molding can be used because it allows for defect-free surfaces to be formed. To perform injection compression molding of domed lens 602, material can be injected into a nearly closed mold. The mold may then be compressed such that the injected material conforms to the shape of the mold. Excess material can be removed, such as through machining.

Domed lens 602 is circular and does not have any holes, vents, gaps, or other discontinuities present on it. Similarly, no holes, vents, gaps, or other discontinuities are present on at least OCA lay 604, tinted ink layer 606, and mirror film layer 608. Having continuous material helps to maintain a consistent visual effect across the entirety of lens assembly 600 as viewed by a user.

OCA lay 604 can be a pressure or temperature sensitive adhesive that adheres domed lens 602 with tinted ink layer 606. Tinted ink layer 606 can be a transparent layer that tints light passing through tinted ink layer 606. Since tinted ink layer 606 is closer to domed lens 602 than mirror film layer 608, both light by mirror film layer 608 and light emitted by electronic display 111 is tinted. The color used for tinting can be selected based on aesthetics.

Mirror film layer 608 may have sufficient reflectivity that when electronic display 111 is not illuminated, a user viewing lens assembly 400 may see a reflection of himself, herself, or the ambient environment. For example, mirror film layer 608 can be Toray® 125FH-40 mirror film. Mirror film layer 608 may be polarized. Due to the way some mirror films are manufactured, throughout a roll of mirror film, the direction of polarization can vary. When a piece of mirror film is stamped or cut out to form mirror film layer 608, the direction of polarization may be determined in order to orient in relation the electronic display, which also outputs polarized light. If orientation is not controlled, visibility of the electronic display through mirror film layer 608 may be adversely affected. Further detail regarding orientation of mirror film layer 608 is detailed in relation to FIG. 7.

Masking layer 610 can be used to block a user from viewing components blocked by the opaque portions of masking layer 610. Masking layer 610 may be black or another dark color to make it difficult to see through mirror film layer 608. Masking layer 610 can obscure a view of frame adhesive 612 and display adhesive 614. Masking layer 610 may be asymmetric. Therefore, it must be oriented in a particular orientation with respect to other components of smart thermostat 200. For example, masking layer 610 includes a hole for an ambient light sensor to have a field of view of the ambient environment through domed lens 602, OCA lay 604, tinted link layer 606, and mirror film layer 608.

Furthermore, the masking layer 610 may help enhance the effect that the electronic display is seamless with lens assembly 400. A color value for masking layer 610 may be selected, having an appropriate lightness value, such that it is difficult or impossible for a user to visually see an edge of the electronic display screen within the smart device. By obscuring an edge of the edge of the electronic display, a user may have the impression that the entire region behind domed lens 602 is electronic display 111.

Obscured behind masking layer 610 may be two separate adhesive layers. Frame adhesive layer 612 may adhere domed lens layer 402, OCA lay 604, tinted link layer 606, mirror film layer 608, and masking layer 610 to display frame 302. Display adhesive layer 614 may adhere domed lens layer 402, OCA lay 604, tinted link layer 606, mirror film layer 608, and masking layer 610 to electronic display 202. Different types of adhesives may be used to provide better adhesion to the material of electronic display 202 and display frame 302. Adhesive layer 612 and display adhesive layer 614 may both be different types of pressure sensitive adhesives (PSAs). In other embodiments, a single adhesive layer may be used. For example, 3M® 5126-025 may be used as the PSA.

FIG. 7 is a cross section 700 of an embodiment of smart thermostat 200. The location and direction of cross section 700 is indicated on FIG. 2B. The domed profile of domed lens 602 is visible in the cross section 700 of FIG. 7. Surface 701 is the outer surface of domed lens 602 that is adjacent the ambient environment and which a user can touch. An entirety of surface 701 is convex from edge to edge. Surface 702 is the inner surface and adheres with OCA layer 604. OCA layer 604 and other layers of lens assembly 600 are not visible in FIG. 7. An entirety of surface 702 can be flat. Surface 703 forms a circumference around the entirety of domed lens 602. Surface 703 is perpendicular or approximately perpendicular (defined as within 5° of perpendicular) to surface 702.

Electronic display 202 is disposed under the domed lens 602 and surrounded by rotatable ring 710. In particular, ring 210 surrounds surface 703 of domed lens 602 and couples to housing 206, which has a cylindrical sidewall 208.

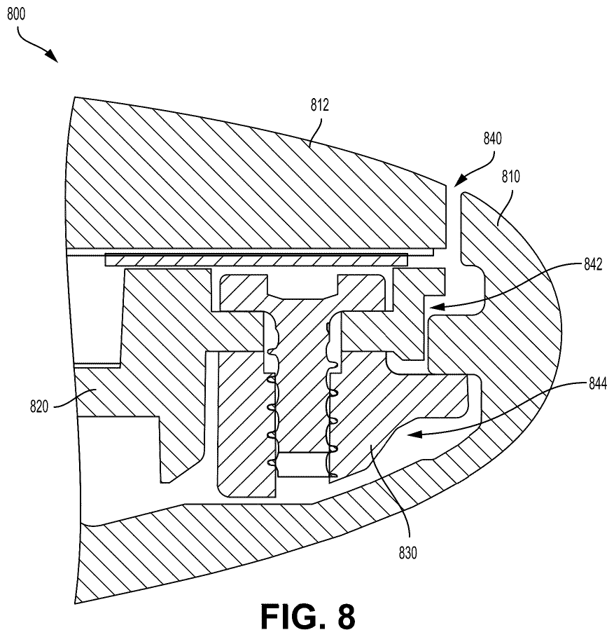

FIG. 8 is an enlarged cross section of a side view of a smart thermostat. Electronic device 800 may be similar to smart thermostat 200 and smart thermostat 500. Similar components may be similarly numbered and have similar form and function unless otherwise noted herein. As shown in FIG. 8, the clip 830, the display frame 820, and the ring 810 are assembled such that a gap 840 is formed between an outer perimeter of the domed lens 812 and a corresponding internal perimeter of the ring 810. In various embodiments, the gap 840 is not visible to the user facing the electronic device 800. For example, the mirrored reflective cover of the domed lens 812 smoothly transitions to the polished finish of the ring 810 with no disruptions. The gap 840 is optimized to be as small as possible while enabling the ring 810 to be rotated relative to the domed lens 812 and/or the electronic display (not shown in this view).

According to various embodiments, the display frame 820 includes a grease trap recess 842 for directing grease between the display frame 820 and the clip 830. For example, grease may be applied between a vertical interface (such as formed by the grease trap recess 842) of the display frame 820 and the ring 810 for continuous rotation of the ring 810 relative to the rest of the electronic device 800 (e.g., including the sidewall of the housing and the backplate) without disruption. In exemplary embodiments, a grease is applied such that the user experiences a pleasing, viscous feeling when rotating the ring 810. The grease may include a damping grease and/or a dry grease. Different types of grease may be applied at different regions between the components unless otherwise noted herein.

In at least some embodiments, the clip 830 is formed to reduce grease shearing between the clip 830 and the ring 810 at location 844. For example, grease applied at the grease trap recess 842 may be displaced to an area proximate location 844. The combination of the tuned gap 840 and grease application enhances the user experience during rotation of the ring 810 and selection of various icons and/or information displayed on the electronic display when the information is visible (e.g., when the electronic display is “ON”) through the domed lens 812.

In various embodiments, one or more temperature sensors (not shown) may be disposed between the ring 810 and the clip 830 and/or the display frame 820. For example, the one or more temperature sensors may be disposed in the portion of the electronic device 800 that overhangs the sidewall (not shown) that mounts the electronic device 800 to a mounting surface. Said another way, the electronic device 800 may form a “mushroom” shape and one or more temperature sensors are disposed proximate an outer perimeter of the “cap” of the mushroom.

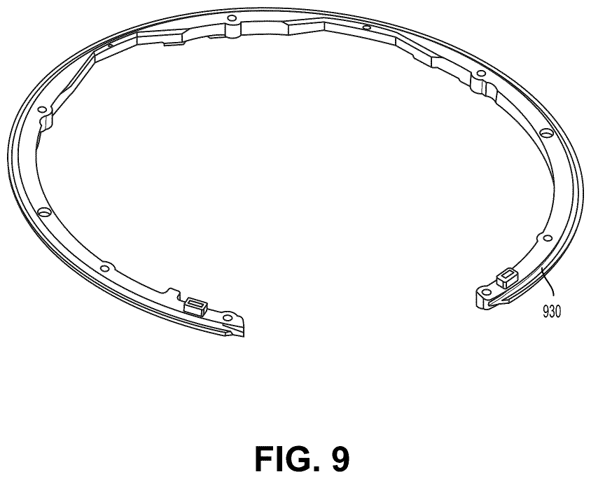

FIG. 9 is clip for use with a smart thermostat. The clip 930 may be of the same type as various clips described herein. The clip 930 may be a C-clip as shown in FIG. 9. The clip 930 acts as an axial constraint for various components of the electronic device and couples at least the display frame and the ring. The clip 930 is optimized for assembly such that the clip 930 is relatively thin within the electronic device housing. The open end of the clip 930 as shown in FIG. 9 enables efficient installation and removal of the clip 930 during servicing or other activities involving disassembling the electronic device.

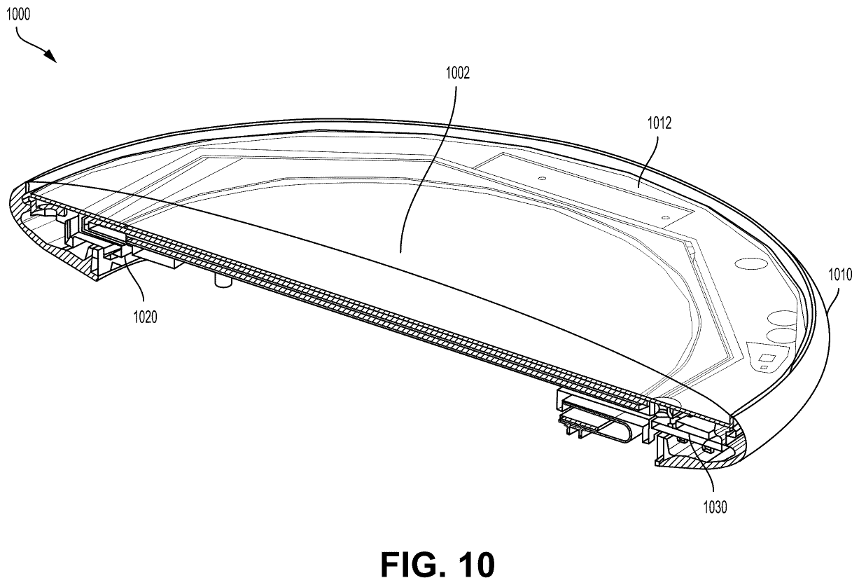

FIG. 10 is an isometric cross section of a side view of a smart thermostat. FIG. 10 provides another view of the various electronic devices described in detail above. In particular, electronic device 1000 may be similar to other electronic devices described above and similar components may be similarly numbered and have similar form and function unless otherwise noted herein. The domed profile of a domed lens 1012 is visible in the cross section of FIG. 10. An electronic display 1002 is disposed under the domed lens 1012 and supported by a ring 1010 and a display frame 1020 as described in detail above. In particular, the ring 1010 surrounds the domed lens 1012. The clip 1030 couples the display frame 1020 supporting the electronic display 1002 to the housing (not shown).

The preceding figures and description make it apparent the many advanced learning and control features that may be implemented by a smart thermostat. Historically, thermostat manufacturers have provided a single set of fixed features that were made available to all users, regardless of their sophistication, experience, or comfort with electronic devices. Furthermore, the single set of fixed features was made available regardless of different power sourcing methods that may have been available to the thermostat. While these feature sets were well within the power and capabilities of previous thermostats, newer thermostats continue to add additional features that add more intelligence, compatibility, and communication to the thermostat as the thermostat is integrated into the overall smart home environment. However, power sourcing methods for thermostats do not always keep up with the advanced feature sets now being offered.

The embodiments described herein solve these and other technical problems by activating feature sets based on whether they can be supported by a selected power sourcing method. For example, thermostats may use a technique known as “power stealing” in order to steal power from the HVAC system. As described in detail below, power stealing techniques generally steal current from a controlled environmental system in order to charge a storage capacitor or rechargeable battery. The stolen energy from the environmental system may be used in conjunction with the stored energy on the storage capacitor or rechargeable battery to power the different features of the smart home device. With specific reference to a thermostat, current may be stolen from the HVAC transformer or call relay used to activate the HVAC system. The timing of this power stealing technique may be calibrated to prevent interfering with the operation of the HVAC system (e.g., accidentally “tripping” or shutting off the HVAC system, etc.). Different algorithms and techniques have been recently discovered for efficiently stealing power from the HVAC system, each of which may provide different levels of power to the thermostat at different times. These embodiments may test an HVAC system to determine which power stealing methods will be compatible with the HVAC system, then select predetermined feature sets that are compatible with the available power stealing methods. This effectively prevents situations high-power features on the thermostat can consume power faster than it can be supplied by the power stealing system and/or the rechargeable capacitor/battery.

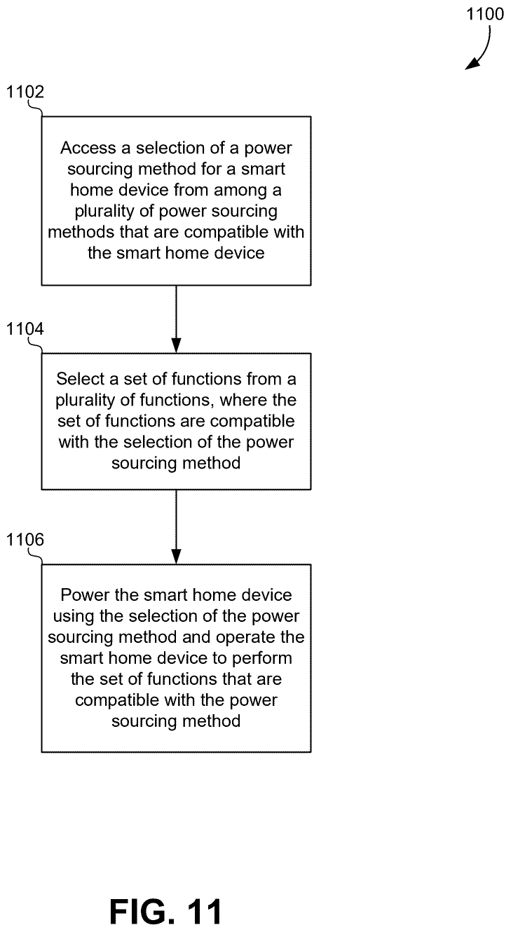

FIG. 11 illustrates a flowchart of a method 1100 for selecting feature sets based on power sourcing methods, according to some embodiments. This method may be carried out by any smart home device. By way of example, this method may be carried out by the smart thermostat described in detail above. For example, the smart home device may include one or more processors configured to execute instructions. Instructions may be stored on one or more memory devices that are communicatively coupled to the one or more processors. The one or more memory devices may provide instructions to the one or more processors, which may cause the one or more processors to perform operations described below. In some embodiments, the one or more processors may be implemented on the smart home device itself. In other embodiments, the processors may be split between the smart home device and other smart home devices in a smart home network, as well as a remote server monitoring the smart home environment. In some embodiments, all operations may be performed remotely, locally, or any combination of the two without limitation.

The method may include accessing a selection of a power sourcing method for a smart home device from among a plurality of power sourcing methods that are compatible with the smart home device (1102). The different power sourcing methods that are available and compatible the smart home device may specifically include power sourcing methods that include sourcing power from an external system that is controlled by the smart home device. Generally, external systems may include any system outside of the smart home device that are capable of providing power to the smart home device. An external system that is controlled by the smart home device may include systems that are controlled specifically by outputs from the smart home device, where those outputs change the function of the external system. For example, a wall outlet would not be controlled by the smart home device, while an HVAC system may represent an external system that is controlled by the smart home device. A subset of the external systems that may be controlled by the smart home device may include environmental systems such as an HVAC system. Other environmental systems may include other heating systems, airflow systems, temperature systems, air quality systems, humidifiers, cleaning systems, and so forth.

Based on the specific type of external or environmental system, the smart home device may be configured to select from among a number of different power sourcing methods that may be compatible with the external or environmental system. For example, different techniques have recently been discovered for controlling the power stealing operations. The term “power stealing” refers to methods that steal current or charge from the wire connectors normally used to control or communicate with the environmental system.

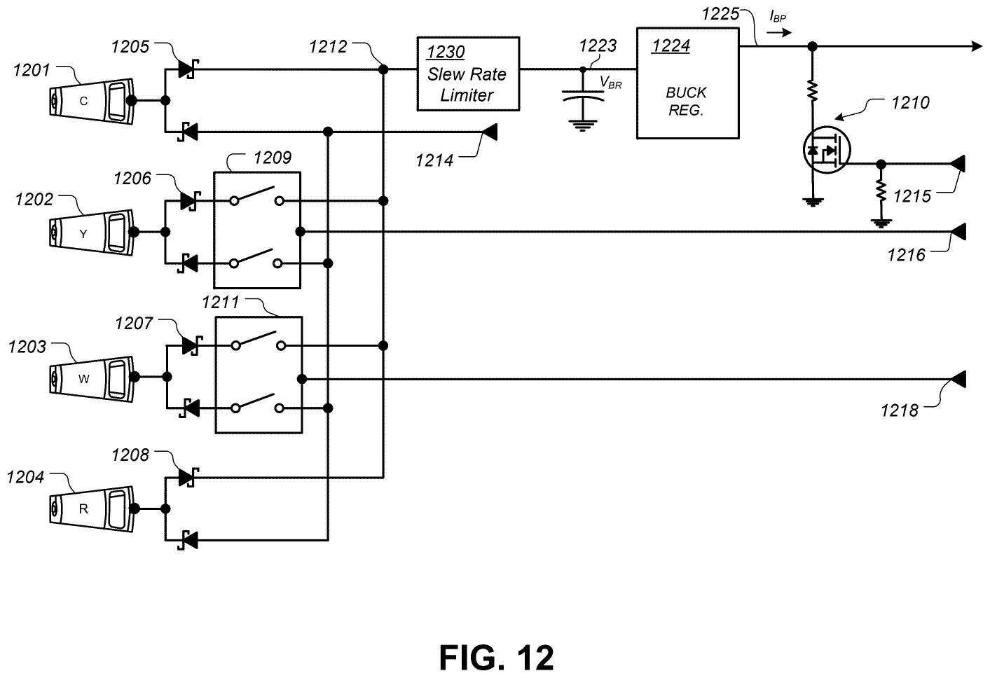

FIG. 12 illustrates a power management and power stealing system for a smart thermostat, according to some embodiments. FIG. 12 shows connections to common HVAC wiring, such as a W (heat call relay wire) wire connector 1203; Y (cooling call relay wire) wire connector 1202; R wire connector (heat/cooling call relay power) 1204; and C (common wire) wire connector 1201. These connectors may collectively be referred to as power wire connectors for the HVAC system, configured to receive a wire from the HVAC system corresponding to a particular function. Note that the wiring connectors may include other wire connectors that are not shown explicitly in FIG. 12, such as an AUX connector, an O/B connector, a G connector, an HUM connector, a Y2 connector, and so forth. These additional inputs may be used to control secondary air conditioners, auxiliary heating elements, humidifiers, heat pumps, and other environmental systems. However, these additional wiring connectors have been omitted from FIG. 6 for clarity and in order to focus on the power-stealing inputs used by the power stealing circuitry. Additionally, the Rc and Rh terminals are represented as the R terminal, since some embodiments may automatically jumper these two wire connectors together unless separate wires are inserted in each of the Re and Rh terminals. Therefore, this disclosure may refer to the R terminal to include either or both of the Re and Rh terminals. Collectively, these may be referred to as return wire connectors for a particular HVAC function.

The thermostat may also comprise a plurality of switching elements (e.g., power MOSFETS) used for carrying out the essential thermostat operations of connecting or “shorting” one or more selected pairs of HVAC wires together according to the desired HVAC operation. The operation of each of the switching elements is controlled by a processor which may comprise, for example, an STM32L 32-bit ultra-low power ARM-based microprocessor available from ST Microelectronics, or the MIMXRT1061VDL6B MCU from NXP Semiconductor.

The thermostat may also include powering circuitry illustrated in FIG. 12. Generally speaking, the purpose of the powering circuitry is to extract or steal electrical operating power from the HVAC wires and convert that power into a usable form for the different components in feature sets of the thermostat. The powering circuitry may include a full-wave bridge rectifier and a storage capacitor 1223 (which can be, for example, on the order of 30-35 microfarads) and a buck regulator 1224. Note that the powering circuitry may include other elements, such as a power-and-battery (PAB) regulation circuit and a battery (not shown). Power stolen from the wires may pass through a slew rate limiter 1230 and charge the storage capacitor 1223. Charge from the storage capacitor 1223 may be provided to the buck regulator 1224, which may in turn provide a rectified voltage output at node 1225 to operate the thermostat and/or to charge a battery. The powering circuitry generally serves to provide a main voltage V_{CC} that is used by the various electrical components of the thermostat, and that in one embodiment may be about 3.7V˜3.95V. The general purpose of powering circuitry is to convert the 24 VAC presented between the selected power and return wires from the HVAC system to a steady DC voltage output at the V_{CC} MAIN node to supply the thermostat electrical power load.

Different techniques may be used to select a power wire connector for power stealing operations. For example, some embodiments may use a mechanical sensing technique that mechanically determines when a wire is inserted into the C wire connector 1201, the Y wire connector 1202, and/or the W wire connector 1203. Alternatively, FIG. 12 illustrates how diode rectification circuits 1205, 1203, 1207, 1208 may replace a bridge rectifier and automatically select between the different input wire connectors. For example, in order to select one of the power wire connectors 1201, 1202, 1203 for power stealing, the voltage drops associated with the diode rectification circuits 1205, 1203, 1207, 1208 may be selected accordingly. Specifically, the forward voltage of each of the diodes in the diode rectification circuits 1205, 1203, 1207, 1208 may be selected to set the order of preference for the power wire connectors 1201, 1202, 1203. For example, the forward voltage drop (e.g., 0.3 V-0.4 V) for the diode rectification circuit 1205 for the C wire connector 1201 may be lower than the forward voltage drop (e.g., 0.5 V-0.6V) for the diode rectification circuit 1206 for the Y wire connector 1202. This will cause the diodes in the diode rectification circuit 1205 to connect to the C wire connector 1201 to node 1212, and also cause the diodes in the diode rectification circuits 1206, 1207 not to conduct, thereby disconnecting the Y wire connector 1202 and/or the W wire connector 1203 from node 1212. Switches 1209, 1211 may be used in conjunction with the diode rectification circuits 1205, 1206, 1207 to isolate and select a single one of the power wire connectors 1201, 1202, 1203. One of the advantages provided by these embodiments is the ability to test and monitor the effect of a power stealing operation on the load in real time as the system operates for any of the selected inputs.

The circuit of FIG. 12 is compatible with a number of different power stealing methods. For example, a first power stealing method may include using current directly from the C wire connector 1201. The C wire connector 1201 may provide a steady and consistent 24 VAC input voltage directly from the HVAC system. When the 24 VAC input voltage is rectified by the diode circuit 1205, a DC voltage at node 1212 is present across the storage capacitor 1223, and this DC voltage is converted by a power converter such as the buck regulator 1224 to a relatively steady voltage, such as 4.4 volts, at node 1225, which provides an input current I_{BP} to the other systems on the thermostat, including a power management system, battery charging system, a main processor, and so forth.

Another method of power stealing enabled by the circuit of FIG. 12 may include stealing power from the Y wire connector 1202 and/or the W wire connector 1203. This type of power stealing may be used for the case in which the “C” wire is not present. As used herein, “inactive power stealing” refers to the power stealing that is performed during periods in which there is no active call in place for an HVAC function (e.g., air conditioning, heating, etc.) based on the lead from which power is being stolen. As used herein, “active power stealing” refers to the power stealing that is performed during periods in which there is an active call in place based on the lead from which power is being stolen.

During inactive power stealing, power is stolen from between, for example, the “Y” wire connector trouble to and the R wire connector 12 four. There may be a 24 VAC HVAC transformer voltage present across these connectors from the HVAC system when no cooling call is in place (i.e., when a corresponding Y-R switching element is open). For one embodiment, the maximum current I_{BP}(max) is set to a relatively modest value, such as 20 mA, for the case of inactive power stealing. Assuming a voltage of about 4.4 volts at node 625, this corresponds to a maximum output power from the buck regulator 624 of about 88 mW. This power level of 88 mW has been found to not accidentally trip the HVAC system into an “on” state due to the current following through the call relay coil. During this time period, the power management system may discharge the battery during any periods of operation in which the instantaneous thermostat electrical power load rises above 88 mW, and to recharge the battery (if needed) when the instantaneous thermostat electrical power load drops below 88 mW. The thermostat may be configured such that the average power consumption is well below 88 mW by only activating some of the feature sets as described below. One available method of power stealing for some of thermostats is to only steal power when the corresponding HVAC function is inactive.

Another power stealing method may include also stealing power when the HVAC function is active. When “active power stealing” during an active heating/cooling call, it may be necessary for current to be flowing through the HVAC call relay coil sufficient to maintain the HVAC call relay in a “tripped” or ON state at all times during the active heating/cooling call. The processor may be configured to turn, for example, a Y-R switching element (not shown) OFF for small periods of time during the active cooling call, wherein the periods of time are small enough such that the cooling call relay does not “un-trip” into an OFF state, but where the periods of time are long enough to allow inrush of current into the wire connectors to keep the storage capacitor 1223 charged to a reasonably acceptable operating level. More specifically, each of the pairs of power/return wire connectors on the thermostat may be separated by one or more switching elements. The switching elements may include any type of switch, including transistors, power transistors, relays, and/or the like. The switching elements may operate in a first operating state (e.g., a “closed” state) that creates a connection between the corresponding power wire connector and the return wire connector. This state may activate the HVAC function, such as sending an active call for air conditioning, heating, etc., to the HVAC system. The switching elements may also operate in a second operating state (e.g., an “open” state) where the switching elements interrupt the connection between the power wire connector and the return wire connector. Active power stealing may include temporarily causing the switching elements to transition from the first state to the second state (e.g., from the closed state to the open state) in order to create a voltage differential between these terminals and allow for power stealing current to be provided to the thermostat. Different power stealing techniques may control the timing of the switches.

As described above, a number of different power sourcing or power stealing methods may be available to a thermostat based on the characteristics of the thermostat, the HVAC system, and other factors. A first power stealing method may be characterized in that the power stealing method is not based on a phase of the current waveform through the one or more switching elements. Instead, this power stealing method may monitor a voltage on the storage capacitor 1223. When the voltage on the storage capacitor 1223 dips below a threshold voltage, the system may activate the active power stealing by repeatedly opening/closing the switching elements until the voltage on the storage capacitor 1223 rises above an upper threshold value. For one embodiment, active power stealing may be achieved in a closed-loop fashion in which the processor monitors the voltage V_{BR} at the input node of the storage capacitor 1223 and actuates a Y-R switching elements as necessary to keep the storage output 1223 charged.

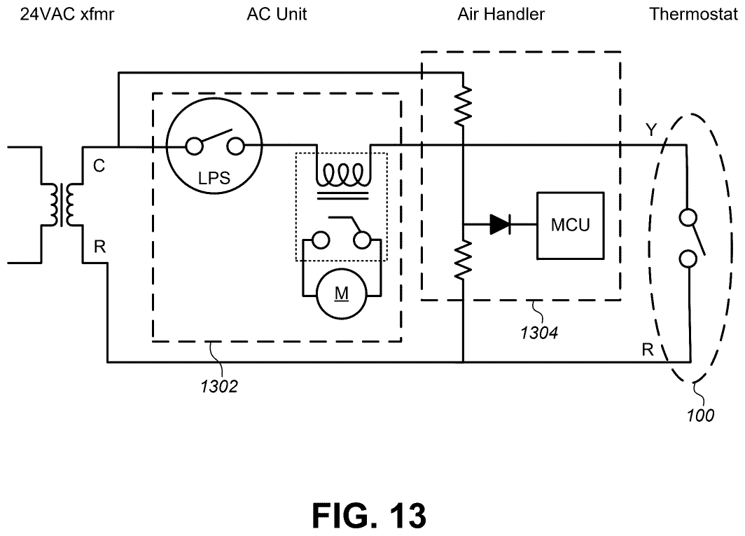

A second, more efficient method of power stealing may be referred to as “synchronous active power stealing,” which may be characterized as being phase-aware of a zero-crossing of a current waveform through the corresponding switching elements. To illustrate how synchronous active power stealing operates, FIG. 13 illustrates a typical modern HVAC system, according to some embodiments. The air conditioning system may include an air handler 1304 inside the house, as well as an air-conditioning unit 1302 outside of the house. When a thermostat calls for a cooling function, the process is slightly more complicated than the process for calling for a heating function. As with the heating function, the thermostat signals the air handler 1304 to start the blower. Additionally, the thermostat switches a large motor inside the AC unit 1302 outside the home, which begins to pump coolant. This large compressor motor typically uses a very large switch known as a “contactor.”

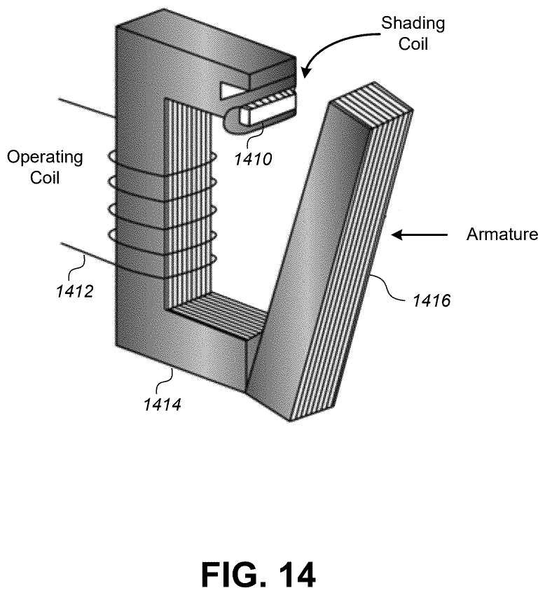

FIG. 14 illustrates a contactor 1414 and the associated current waveforms used to activate the contactor 1414, according to some embodiments. Unlike the heating system, which may be triggered by using tens of microamps of current, the contactor 1414 may take hundreds of milliamps of current to trigger. While this makes the contactor 1414 ideal for power stealing, it also presents unique difficulties when ensuring that the power stealing function does not interfere with the operation of the contactor 1414. Unlike general-purpose relays, contactors are designed to be directly connected to high-current load devices, such as the air conditioner motor outside the home.

The basic operation for the contactor 1414 follows the general principles of an electromagnet. To close the contactor, a current is passed through the operating coil 1412. This causes a magnetic field to be generated in the contactor 1414 and close the armature 1416. When an alternating current is passed through the operating coil 1412, zero crossings of the AC current would normally result in a reduction of the magnetic field, which would cause the contactor 1414 to release the armature 1416 from its closed position. To prevent the armature 1416 from opening during zero crossings in the operating coil 1412, a contactor 1414 may include a shading coil 1410. The shading coil may include a small number of turns of an electrical conductor located in the face of the contactor 1414. A shading coil current 1404 that is passed through the shading coil 1410 may be out of phase from the operating coil current 1402 passing through the operating coil 1412. For example, some embodiments may use a 90° phase shift in the shading coil current 1404 in comparison to the operating coil current 1402. This phase shift allows the shading coil 1410 to hold the armature 1416 in place when the operating coil current 1402 allows the main flux in the contactor 1414 to fall to zero.

Instead of timing the active power stealing windows based on a measured voltage on the storage capacitor 1223, synchronous active power stealing times the power stealing windows on the zero crossings of the current waveforms. When regular active power stealing and the voltage on the storage capacitor 1223 drops below a threshold, a processor would initiate a power stealing interval, which would open a switch between, for example, the Y wire connector and the corresponding return wire connector causing a voltage differential between these two wire connectors. The current that was previously passing through the switch would then be sent into the storage capacitor 622. The switch would remain open until the voltage on the storage capacitor 622 exceeded an upper threshold, or until a time limit for active power stealing was reached.

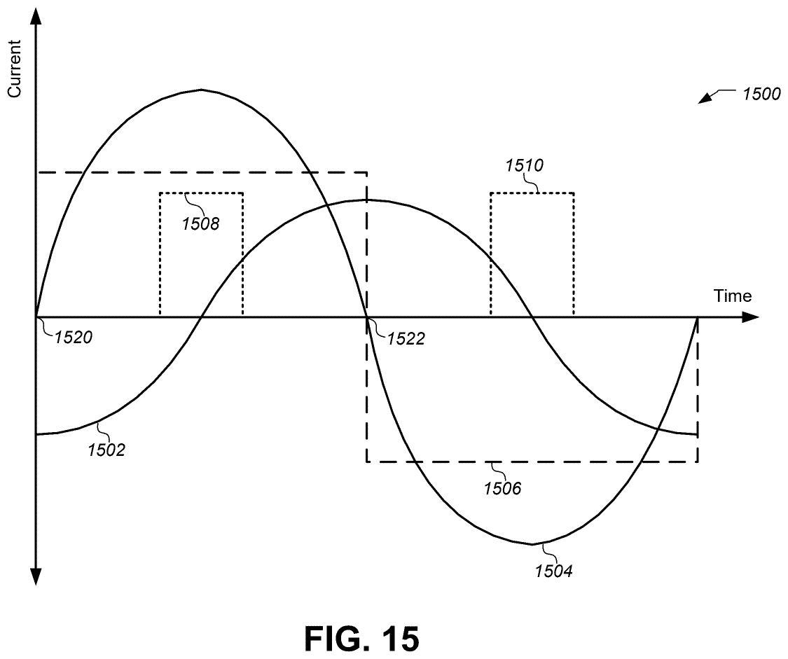

FIG. 15 illustrates a graph 1500 of waveforms present in the contactor of the air conditioning system and the switch of the thermostat, according to some embodiments. First, the graph 1500 includes the operating coil current 1504 of the contactor. The operating coil current is an AC signal operating at edges such as approximately 50 Hz or approximately 60 Hz. For reference, the shading coil current 1502 is also illustrated as an AC current having the same frequency as the operating coil current 1504, but shifted 90° out of phase relative to the operating coil current 1504. The zero-crossing output provided by the switching elements described above is illustrated as a zero-crossing square wave 1506. Note that the vertical axis of the graph 1500 is illustrated in terms of a current measurement. However, the current of the vertical axis applies only to the operating coil current 1504 and the shading coil current 1502. The output of the zero-crossing square wave 1506 may be displayed in terms of voltage. However, these are shown on the same graph to emphasize the relative timing of the operating coil current 1504 and the zero-crossing square wave 1506.

Synchronous active power stealing may utilize the timing information provided by the zero-crossing square wave 1506 in order to time the active power-stealing window for the device. For example, some embodiments may start a timer when a zero crossing occurs. The timer may be configured to act as a delay between the zero-crossing event and the start of an active power-stealing window 1508. The length of the timer may be configured to start the active power-stealing window 1508 relative to a peak of the operating coil current 1504. In some embodiments, the active power-stealing window 1508 may be centered around a peak of the operating coil current 1504. In other embodiments, the active power-stealing window 1508 may be timed such that it is not necessarily centered around the peak of the operating coil current 1504, but instead is shifted to occur during a later portion of the half cycle of the operating coil current 1504. Alternatively, the active power-stealing window 1508 may be shifted to occur during a first portion of the half cycle of the operating coil current 1504.

This process for determining a start time for the active power-stealing window 1508 may be performed repeatedly with each zero crossing of the zero-crossing square wave 1506 received from the switching elements. For example, when a first zero crossing 1520 is detected, a first timer may begin. At the expiration of the first timer, a first active power-stealing window 1508 may be initiated. The length of the first active power-stealing window 1508 may be determined by another, second timer operation, which may reuse the same timer or start a new timer. When this subsequent, second timer operation expires, the active power-stealing window 1508 may be terminated. When a second and subsequent zero crossing 1522 occurs, the same process may be repeated. For example, the timer may be restarted and a second active power-stealing window 1510 may be started at the second expiration of the first timer. Thus, each half cycle of the operating coil current 1504 may include a corresponding active power-stealing window. These active power-stealing windows 1508, 1510 need not necessarily trigger the beginning of an active power-stealing operation. Instead, these active power-stealing windows 1508, 1510 may act as enable windows that indicate when active power-stealing operations may be carried out by the switching elements.

Described above are at least three different power stealing methodologies, including inactive power stealing, active power stealing, synchronous active power stealing, and so forth. These categories are not meant to be limiting. For example, synchronous active power stealing may include additional power stealing methods. Synchronous active power stealing may turn on for a set period of time based on a timer before turning off. Synchronous active power stealing may also be configured to charge the capacitor to a specific value. Synchronous active power stealing may turn off when the power stealing window is over, and so forth. Each of these different variations may be considered a different power stealing method.

When the smart home device initially makes a determination as to which power stealing method to use, the smart home device may first test each of the different power stealing techniques to determine whether the HVAC system and any associated transformers are capable of sourcing enough power for the selected power stealing method. For example, based on the discussion above, synchronous active power stealing may require specific HVAC hardware, such as an outdoor air-conditioning unit that has a relatively large relay from which current may be sourced. If the relay is too small, then the HVAC system may not be compatible with synchronous active power stealing or other similar power stealing methods. Therefore, some embodiments may first determine a power stealing method that is compatible with the thermostat and the HVAC equipment.

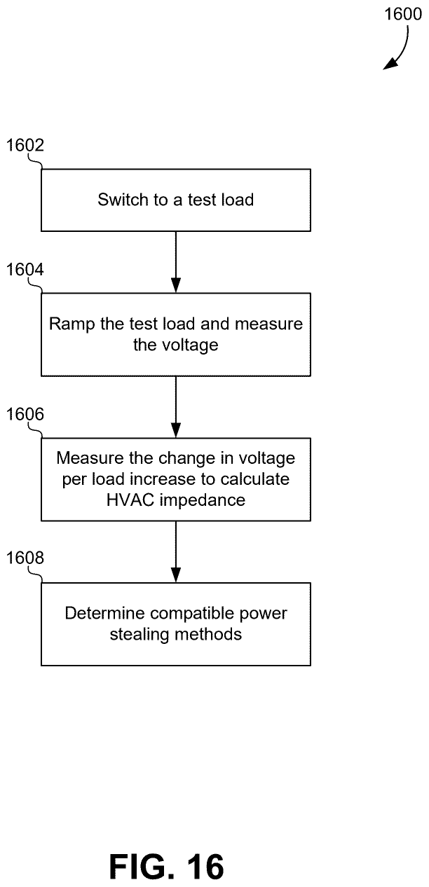

FIG. 16 illustrates a flowchart of a method 1600 for testing different power stealing methods, according to some embodiments. The method may include switching to a test load (1602). The test load may isolate the rest of the smart home device from the power provided by the external system. For example, the test load may isolate the rest of the thermostat from the power provided from the HVAC system. Turning back to FIG. 12, the schematic illustrates a circuit for testing and/or characterizing signals provided by the power wire connectors, according to some embodiments. A programmable resistive load 1210 may be set by a signal 1215 from a microprocessor. The resistive load 1210 may be used to vary how much of a load the system provides for the external environmental system under control, such as an HVAC system. The resistive load 1210 may be placed between the system power and the system ground at the output of a power converter, such as the buck converter. The resistive load 1210 may be varied by a PWM signal provided through signal 1215 from the microprocessor. Varying signal 1215 may change the conductance of the transistor in the resistive load 1210 and thereby change the impedance of the internal load 1210 seen by the HVAC system. In some embodiments, the signal 1215 may be generated by a controlled stable current with an op amp feedback circuit instead of a pulsed current with a PWM circuit. The resistive load may also be implemented by one or more resistors in parallel, series, and/or combination. For example, a plurality of parallel resistors may be used to spread the heat generated out over a number of different discrete parts.

The method may also include ramping up the test load and measuring the change in voltage (1604). For example, some embodiments may gradually increase the impedance provided by the internal load 1210 and measure the voltage drop across the internal load 1210 to estimate the impedance of the external load coupled to the corresponding power wire connector. The change in the input voltage caused by the change in current may be used to calculate or estimate the impedance of the HVAC system beyond the connector. For example, the method may include measuring the change in voltage per a given load increased to calculate HVAC impedance (1606). When the test load is increased, the rate at which the input voltage drops for a given increase in the load may be used as a proxy to estimate the source impedance of any elements in series with the circuit providing power at the HVAC system.

Alternatively, some embodiments may measure the voltage drop caused by the load at the input to the buck regulator 1224. The system is aware of how much extra current the load is pulling (since the system sets this value), and a current measurement circuit may measure the total current out of the buck regulator 1224. The change in the input voltage caused by the change in current may be used to calculate the impedance of the HVAC system beyond the connector. For example, the Y wire connector 1202 may be isolated by opening the switches 1211 for the W wire connector 1203. The internal load 1210 may be adjusted, and the impedance of the connection through the Y wire connector 1202 may be measured. A similar process may be used to test and characterize the signal through the W wire connector 1203 by opening the switches 1209 and closing the switches 1211.

After characterizing the impedance of each of the external loads connected through the power wire connectors, the system may identify or select a compatible power stealing method (1608). For example, to be compatible with synchronous active power stealing, the relay of the HVAC system should have a relatively low impedance (e.g., less than about 10 ohms). This will result in a relatively small voltage drop as the test load ramps up in resistance. Once the test load gets up to about 200 mOhms, the voltage may have dropped by less than about 4 V, which may indicate that the power source has a low enough impedance to be used for synchronous active power stealing. More generically, the system may estimate an impedance and compare that estimated impedance to a threshold value that is compatible with each available power stealing method.

Some embodiments may subsequently test the power stealing method by enabling the power stealing method and again running the test load. For example, for synchronous active power stealing, the switching elements may turn off during the predetermined active power stealing window as described above. Instead of charging the storage capacitor 1223 between 5 V and 8 V, much higher voltage thresholds may be used (e.g., 24 V to about 32 V). As the resistance of the test load again ramps upwards, the voltage drop may be monitored to ensure that the selected power stealing method is delivering enough power for different loads that may be experienced by the smart home device.

The process illustrated in FIG. 16 may be used to select a power stealing method from among a plurality of different power sourcing methods. As described above, these may include first, second, third, etc., power stealing methods, some of which may be based on a phase of a current waveform from the HVAC system. Turning back to FIG. 11, the method of selecting a feature set for the smart home device may further include selecting a set of functions from a plurality of functions (1104). This set of functions may be compatible with the selection of the power sourcing method.

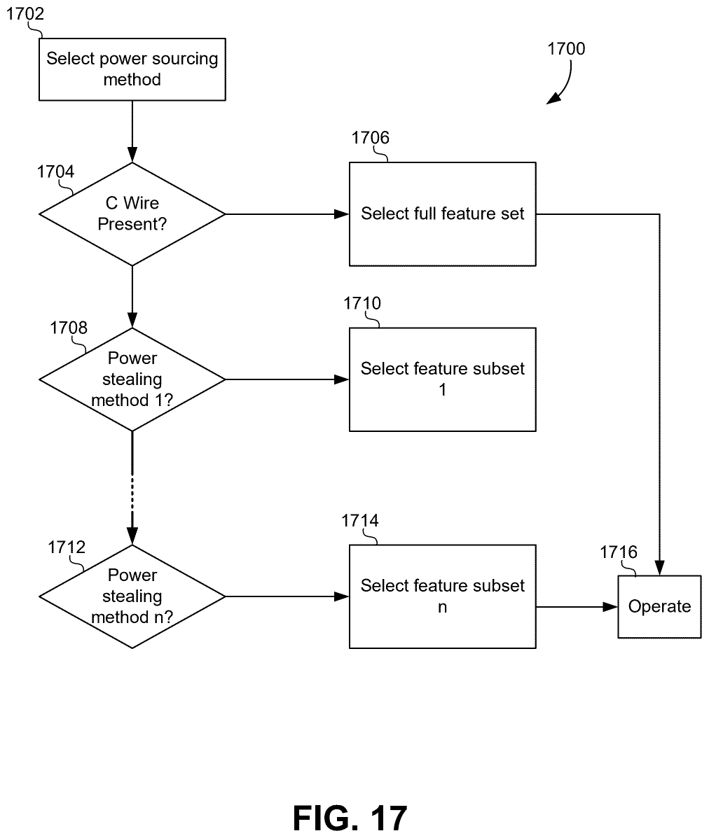

FIG. 17 illustrates a flowchart of a method 1700 for selecting a feature set based on a selected power sourcing method, according to some embodiments. The method 1700 may include selecting a power sourcing method (1702). Selecting a power sourcing method may include any power source, and may specifically include selecting a power stealing method from among a plurality of available methods. The selection process for determining a power stealing method may use the test process described in detail above in FIG. 16. This operation may be performed by one or more processors on the smart-home device.

The method 1700 may also include determining whether a dedicated power supply is available. In the example of a thermostat, this may include determining whether a C wire is present (1704). If a C wire is present, this may indicate that a relatively large amount of power is available to the thermostat. In this case, the full feature set of the smart home device may be enabled (1706). The full feature set may include things such as operating as an edge router between the local Wi-Fi network and a Thread network. The full feature set may include a function that wakes the display of a thermostat when a user approach is detected. The full feature set may include operating a radar sensor to detect human occupancy. The full feature set may include increasing sampling and/or transmission rates for sensors and wireless communications. The full feature set may include a maximum brightness level for a display or a time during which the display may be active. The full feature set may include executing various algorithms using the main processor of the thermostat, including learning algorithms, artificial intelligence algorithms, complex models, and schedule adjustments. The full feature set may include charging a rechargeable battery or storage capacitor. The full feature set may include controlling various functions on the HVAC system. In short, the full feature set may include any operations performed by the smart thermostat. Other smart-home devices may include other features that are more specific to their operating functions and environments.

The method 1700 may include determining, if a dedicated power supply is not present, that a first power stealing method may be used (1708). In the example of a thermostat, this may include advanced power stealing methods such as synchronous active power stealing. In some embodiments, synchronous active power stealing may also activate the full feature set of the thermostat. In other embodiments, certain features in the full feature set may be disabled to form a feature subset for use with this power stealing method (1710). For example, some embodiments may disable edge routing functions between various wireless communication networks if a dedicated power line (e.g., a C wire) is not present. Other embodiments may decrease a sensor polling frequency or the frequency with which wireless communications are transmitted. Note that these features are provided only by way of example and are not meant to be limiting. Any subset of features may be used with a first power stealing method.

As described above, numerous different power stealing methods may be available, each of which may provide varying levels of power to the thermostat. As illustrated in FIG. 17, each of these different power stealing methods may be associated with a subset of the features that may be active on the smart home device. As a general proposition, when a particular power stealing method n is selected (1712), a corresponding feature subset n may also be selected (1714). For example, some power stealing methods may enable edge routing when a first power stealing method is selected and disable power stealing when the second power stealing method is selected. The same may be true for waking the display of the thermostat when a user approach is detected, using the radar sensor to detect human occupancy, switching between various wireless transmission rates, and so forth. Generally, higher power features may be enabled with power stealing methods that generate more power for the smart home device, while these higher power features may be disabled with power stealing methods that generate less power for the smart home device.

The method 1700 may also include powering the smart home device using the selection of the power sourcing method and operating the smart home device to perform the set of functions that are compatible with the power sourcing method (1716). This operation may also be performed by the method 1100 of FIG. 11 (1106). In some embodiments, this may be dynamically changed during operation. For example, based on different environmental factors, such as a load on HVAC system or power consumption of the thermostat, the thermostat may switch between different power stealing methods. When the switch occurs, the corresponding feature set may also be enabled/disabled dynamically at runtime of the thermostat. This may be accompanied by a notification to a user or may be transparent to the user.

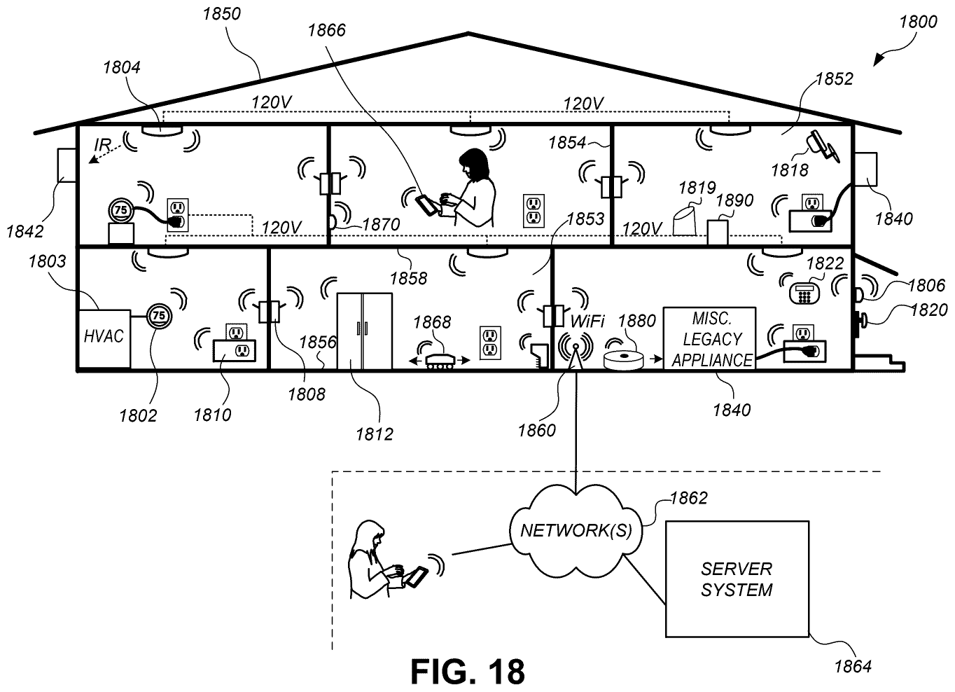

FIG. 18 illustrates an example smart home environment 1800. As shown in FIG. 18, the smart home environment 1800 includes a structure 1850 (e.g., a house, daycare, office building, apartment, condominium, garage, or mobile home) with various integrated devices. It will be appreciated that devices may also be integrated into a smart home environment 1800 that does not include an entire structure 1850, such as an apartment, condominium or office space. Further, the smart home environment 1800 may control and/or be coupled to devices outside of the actual structure 1850. Indeed, several devices in the smart home environment 1800 need not be physically within the structure 1850 (e.g., although not shown, a pool heater, an irrigation system, and the like).

The term “smart home environment” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or workspace. Similarly, while the terms user, customer, installer, homeowner, occupant, guest, tenant, landlord, repair person, and the like may be used to refer to the person or persons acting in the context of some particular situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. While the identity of the person performing the action may be germane to a particular advantage provided by one or more of the implementations, such identity should not be construed in the descriptions that follow as necessarily limiting the scope of the present teachings to those particular individuals having those particular identities.

The depicted structure 1850 includes a plurality of rooms 1852, separated at least partly from each other via walls 1854. The walls 1854 may include interior walls or exterior walls. Each room may further include a floor 1856 and a ceiling 1858. Devices may be mounted on, integrated with and/or supported by a wall 1854, floor 1856, or ceiling 1858.

In some implementations, the integrated devices of the smart home environment 1800 include intelligent, multi-sensing, network-connected devices that integrate seamlessly with each other in a smart home network and/or with a central server or a cloud-computing system to provide a variety of useful smart home functions. The smart home environment 1800 may include, among other things, one or more intelligent, multi-sensing, network-connected thermostats 1802 (hereinafter referred to as “smart thermostats 1802”), hazard detection units 1804 (hereinafter referred to as “smart hazard detectors 1804”), entryway interface devices 1806 and 1820, and alarm systems 1822 (hereinafter referred to as “smart alarm systems 1822”).

A smart thermostat may detect ambient climate characteristics (e.g., temperature and/or humidity) and control an HVAC system 1803 accordingly. For example, a respective smart thermostat includes an ambient temperature sensor. In some implementations, a respective smart thermostat also includes one or more sensors (e.g., an ambient light sensor and/or a radar sensor) that may be used to control an operation of the respective smart thermostat. For example, based on radar data acquired from a radar sensor included in the smart thermostat and an ambient light level measure by an ambient light sensor included in the smart thermostat, as described above, a display of the smart thermostat may be controlled.

A smart hazard detector may detect smoke, carbon monoxide, and/or some other hazard present in the environment. The one or more smart hazard detectors 1804 may include thermal radiation sensors directed at respective heat sources (e.g., a stove, oven, other appliances, a fireplace, etc.). For example, a smart hazard detector 1804 in a kitchen 1853 includes a thermal radiation sensor directed at a network-connected appliance 1812. A thermal radiation sensor may determine the temperature of the respective heat source (or a portion thereof) at which it is directed and may provide corresponding black-body radiation data as output.

The smart doorbell 1806 and/or the smart door lock 1820 may detect a person's approach to or departure from a location (e.g., an outer door), control doorbell/door locking functionality (e.g., receive user inputs from a portable electronic device 1866 to actuate the bolt of the smart door lock 1820), announce a person's approach or departure via audio or visual means, and/or control settings on a security system (e.g., to activate or deactivate the security system when occupants go and come). In some implementations, the smart doorbell 1806 includes a camera, and, therefore, is also called “doorbell camera 1806” in this document.

The smart alarm system 1822 may detect the presence of an individual within close proximity (e.g., using built-in IR sensors), sound an alarm (e.g., through a built-in speaker, or by sending commands to one or more external speakers), and send notifications to entities or users within/outside of the smart home environment 1800. In some implementations, the smart alarm system 1822 also includes one or more input devices or sensors (e.g., keypad, biometric scanner, NFC transceiver, microphone) for verifying the identity of a user, and one or more output devices (e.g., display, speaker). In some implementations, the smart alarm system 1822 may also be set to an armed mode, such that detection of a trigger condition or event causes the alarm to be sounded unless a disarming action is performed.

In some implementations, the smart home environment 1800 includes one or more intelligent, multi-sensing, network-connected wall switches 1808 (hereinafter referred to as “smart wall switches 1808”), along with one or more intelligent, multi-sensing, network-connected wall plug interfaces 1810 (hereinafter referred to as “smart wall plugs 1810”). The smart wall switches 1808 may detect ambient lighting conditions, detect room-occupancy states, and control a power and/or dim state of one or more lights. In some instances, smart wall switches 1808 may also control a power state or speed of a fan, such as a ceiling fan. The smart wall plugs 1810 may detect occupancy of a room or enclosure and control the supply of power to one or more wall plugs (e.g., such that power is not supplied to the plug if nobody is at home).

In some implementations, the smart home environment 1800 of FIG. 18 includes a plurality of intelligent, multi-sensing, network-connected appliances 1812 (hereinafter referred to as “smart appliances 1812”), such as refrigerators, stoves, ovens, televisions, washers, dryers, lights, stereos, intercom systems, wall clock, garage-door openers, floor fans, ceiling fans, wall air conditioners, pool heaters, irrigation systems, security systems, space heaters, window AC units, motorized duct vents, and so forth. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 1840, such as old conventional washer/dryers, refrigerators, and the like, which may be controlled by smart wall plugs 1810. The smart home environment 1800 may further include a variety of partially communicating legacy appliances 1842, such as infrared (“IR”) controlled wall air conditioners or other IR-controlled devices, which may be controlled by IR signals provided by the smart hazard detectors 1804 or the smart wall switches 1808.

In some implementations, the smart home environment 1800 includes one or more network-connected cameras 1818 that are configured to provide video monitoring and security in the smart home environment 1800. Cameras 1818 may be mounted in a location, such as indoors and to a wall or can be moveable and placed on a surface. Various embodiments of cameras 1818 may be installed indoors or outdoors. Cameras 1818 may be used to determine occupancy of the structure 1850 and/or particular rooms 1852 in the structure 1850, and thus may act as occupancy sensors. For example, video captured by the cameras 1818 may be processed to identify the presence of an occupant in the structure 1850 (e.g., in a particular room). Specific individuals may be identified based, for example, on their appearance (e.g., height, face) and/or movement (e.g., their walk/gait). Cameras 1818 may additionally include one or more sensors (e.g., IR sensors, motion detectors), input devices (e.g., microphone for capturing audio), and output devices (e.g., speaker for outputting audio). In some implementations, the cameras 1818 are each configured to operate in a day mode and in a low-light mode (e.g., a night mode). In some implementations, the cameras 1818 each include one or more IR illuminators for providing illumination while the camera is operating in the low-light mode. In some implementations, the cameras 1818 include one or more outdoor cameras. In some implementations, the outdoor cameras include additional features and/or components such as weatherproofing and/or solar ray compensation.

The smart home environment 1800 may additionally or alternatively include one or more other occupancy sensors (e.g., the smart doorbell 1806, smart door locks 1820, touch screens, IR sensors, microphones, ambient light sensors, motion detectors, smart nightlights 1870, etc.). In some implementations, the smart home environment 1800 includes radio-frequency identification (RFID) readers (e.g., in each room or a portion thereof) that determine occupancy based on RFID tags located on or embedded in occupants. For example, RFID readers may be integrated into the smart hazard detectors 1804.

Smart home assistant 1819 may have one or more microphones that continuously listen to an ambient environment. Smart home assistant 1819 may be able to respond to verbal queries posed by a user, possibly preceded by a triggering phrase. Smart home assistant 1819 may stream audio and, possibly, video if a camera is integrated as part of the device, to a cloud-based server system 1864 (which represents an embodiment of cloud-based server system 150 of FIG. 1). Smart home assistant 1819 may be a smart device through which non-auditory discomfort alerts may be output and/or an audio stream from the streaming video camera can be output.

By virtue of network connectivity, one or more of the smart-home devices may further allow a user to interact with the device even if the user is not proximate to the device. For example, a user may communicate with a device using a computer (e.g., a desktop computer, laptop computer, or tablet) or another portable electronic device 1866 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart home environment 1800 using a network-connected computer or portable electronic device 1866. In some examples, some or all of the occupants (e.g., individuals who live in the home) may register their portable electronic device 1866 with the smart home environment 1800. Such registration may be made at a central server to authenticate the occupant and/or the device as being associated with the home and to give permission to the occupant to use the device to control the smart devices in the home. An occupant may use their registered portable electronic device 1866 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering portable electronic devices 1866, the smart home environment 1800 may make inferences about which individuals live in the home and are therefore occupants and which portable electronic devices 1866 are associated with those individuals. As such, the smart home environment may “learn” who is an occupant and permit the portable electronic devices 1866 associated with those individuals to control the smart devices of the home.

In some implementations, in addition to containing processing and sensing capabilities, smart thermostat 1802, smart hazard detector 1804, smart doorbell 1806, smart wall switch 1808, smart wall plug 1810, network-connected appliances 1812, cameras 1818, smart home assistant 1819, smart door lock 1820, and/or smart alarm system 1822 (collectively referred to as “the smart-home devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, Matter, ZigBee, 3LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

In some implementations, the smart devices serve as wireless or wired repeaters. In some implementations, a first one of the smart devices communicates with a second one of the smart devices via a wireless router. The smart devices may further communicate with each other via a connection (e.g., network interface 1860) to a network, such as the Internet. Through the Internet, the smart devices may communicate with a cloud-based server system 1864 (also called a cloud-based server system, central server system, and/or a cloud-computing system herein). Cloud-based server system 1864 may be associated with a manufacturer, support entity, or service provider associated with the smart device(s). In some implementations, a user is able to contact customer support using a smart device itself rather than needing to use other communication means, such as a telephone or Internet-connected computer. In some implementations, software updates are automatically sent from cloud-based server system 1864 to smart devices (e.g., when available, when purchased, or at routine intervals).

In some implementations, the network interface 1860 includes a conventional network device (e.g., a router), and the smart home environment 1800 of FIG. 18 includes a hub device 1880 that is communicatively coupled to the network(s) 1862 directly or via the network interface 1860. The hub device 1880 is further communicatively coupled to one or more of the above intelligent, multi-sensing, network-connected devices (e.g., smart devices of the smart home environment 1800). Each of these smart devices optionally communicates with the hub device 1880 using one or more radio communication networks available at least in the smart home environment 1800 (e.g., Matter, ZigBee, Z-Wave, Insteon, Bluetooth, Wi-Fi and other radio communication networks). In some implementations, the hub device 1880 and devices coupled with/to the hub device can be controlled and/or interacted with via an application running on a smart phone, household controller, laptop, tablet computer, game console or similar electronic device. In some implementations, a user of such a controller application can view the status of the hub device or coupled smart devices, configure the hub device to interoperate with smart devices newly introduced to the home network, commission new smart devices, and adjust or view settings of connected smart devices, etc. In some implementations the hub device extends capabilities of low capability smart devices to match capabilities of the highly capable smart devices of the same type, integrates functionality of multiple different device types—even across different communication protocols—and is configured to streamline adding of new devices and commissioning of the hub device. In some implementations, hub device 1880 further includes a local storage device for storing data related to, or output by, smart devices of smart home environment 1800. In some implementations, the data includes one or more of: video data output by a camera device, metadata output by a smart device, settings information for a smart device, usage logs for a smart device, and the like.

In some implementations, smart home environment 1800 includes a local storage device 1890 for storing data related to, or output by, smart devices of smart home environment 1800. In some implementations, the data includes one or more of: video data output by a camera device (e.g., cameras 1818 or smart doorbell 1806), metadata output by a smart device, settings information for a smart device, usage logs for a smart device, and the like. In some implementations, local storage device 1890 is communicatively coupled to one or more smart devices via a smart home network. In some implementations, local storage device 1890 is selectively coupled to one or more smart devices via a wired and/or wireless communication network. In some implementations, local storage device 1890 is used to store video data when external network conditions are poor. For example, local storage device 1890 is used when an encoding bitrate of cameras 1818 exceeds the available bandwidth of the external network (e.g., network(s) 1862). In some implementations, local storage device 1890 temporarily stores video data from one or more cameras (e.g., cameras 1818) prior to transferring the video data to a server system (e.g., cloud-based server system 1864).

Further included and illustrated in the exemplary smart home environment 1800 of FIG. 18 are service robots 1868, each configured to carry out, in an autonomous manner, any of a variety of household tasks. For some embodiments, the service robots 1868 can be respectively configured to perform floor sweeping, floor washing, etc.

In some embodiments, a service robot may follow a person from room to room and position itself such that the person can be monitored while in the room. The service robot may stop in a location within the room where it will likely be out of the way, but still has a relatively clear field-of-view of the room.

The systems and methods of the present disclosure may be implemented using hardware, software, firmware, or a combination thereof and may be implemented in one or more computer systems or other processing systems. Some embodiments of the present disclosure include a system including a processing system that includes one or more processors. In some embodiments, the system includes a non-transitory computer readable storage medium containing instructions which, when executed on the one or more processors, cause the system and/or the one or more processors to perform part or all of one or more methods and/or part or all of one or more processes disclosed herein. Some embodiments of the present disclosure include a computer-program product tangibly embodied in a non-transitory machine-readable storage medium, including instructions configured to cause the system and/or the one or more processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

As used herein, the terms “about” or “approximately” or “substantially” may be interpreted as being within a range that would be expected by one having ordinary skill in the art in light of the specification.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

What is claimed is:

1. A thermostat comprising:
a power wire connector for controlling a heating, ventilation, and air conditioning (HVAC) function of an HVAC system;
a return wire connector for the HVAC function;
one or more switching elements configured to operate in:
a first operating state in which the one or more switching elements create a connection between the power wire connector and the return wire connector to activate the HVAC function; and
a second operating state in which the one or more switching elements interrupt the connection between the power wire connector and the return wire connector; and
one or more processors programmed to perform operations comprising:
controlling a timing of the one or more switching elements to steal power from the HVAC according to at least a first power-stealing method or a second power-stealing method;
selecting a power stealing method from at least the first power-stealing method or the second power-stealing method based at least in part on a characteristic of the HVAC system; and
selecting a set of functions from a plurality of functions of the thermostat to be active, wherein the set of functions are compatible with the power stealing method.

2. The thermostat of claim 1, wherein the set of functions comprises edge routing between a local Wi-Fi network and a Thread network, wherein the edge routing is enabled when the first power-stealing method is selected and disabled when the second power-stealing method is selected.

3. The thermostat of claim 1, wherein the set of functions comprises waking a display of the thermostat when a user approach is detected, wherein the waking of the display is enabled when the first power-stealing method is selected and disabled when the second power-stealing method is selected.

4. The thermostat of claim 1, wherein the set of functions comprises using a radar sensor to detect human occupancy, wherein using the radar sensor is enabled when the first power-stealing method is selected and disabled when the second power-stealing method is selected.

5. The thermostat of claim 1, wherein the set of functions comprises a wireless transmission rate, wherein a first wireless transmission rate is enabled when the first power-stealing method is selected, and a second wireless transmission rate is enabled when the second power-stealing method is selected, wherein the first wireless transmission rate is greater than the second wireless transmission rate.

6. The thermostat of claim 1, wherein the first power-stealing method comprises a timing of the one or more switching elements that is phase-aware of a zero-crossing of a current waveform through the one or more switching elements.

7. The thermostat of claim 1, wherein the second power-stealing method comprises a timing of the one or more switching elements that is not based on a phase of a current waveform through the one or more switching elements.

8. A method comprising:
accessing a selection of a power sourcing method for a smart home device from among a plurality of power sourcing methods that are compatible with the smart home device, wherein the plurality of power sourcing methods comprises sourcing power from an environmental system that is controlled by the smart home device;
based on the selection of the power sourcing method, selecting a set of functions from a plurality of functions, wherein the set of functions are compatible with the selection of the power sourcing method; and
powering the smart home device using the selection of the power sourcing method and operating the smart home device to perform the set of functions that are compatible with the power sourcing method.

9. The method of claim 8, wherein the plurality of power sourcing methods comprises sourcing power from a dedicated power line from the environmental system.

10. The method of claim 9, wherein the dedicated power line from the environmental system comprises a C wire from an HVAC system.

11. The method of claim 8, wherein the smart home device comprises a thermostat.

12. The method of claim 8, wherein the smart home device comprises a smart doorbell.

13. A smart home device comprising:
one or more wire connectors configured to receive wires from an external system, wherein the smart home device is configured to control the external system; and
one or more processors configured to perform operations comprising:
accessing a selection of a power sourcing method for a smart home device from among a plurality of power sourcing methods that are compatible with the smart home device, wherein the plurality of power sourcing methods comprises sourcing power from the external system that is controlled by the smart home device;
based on the selection of the power sourcing method, selecting a set of functions from a plurality of functions of the smart home device, wherein the set of functions are compatible with the selection of the power sourcing method; and
powering the smart home device using the selection of the power sourcing method and operating the smart home device to perform the set of functions that are compatible with the power sourcing method.

14. The smart home device of claim 13, wherein the operations further comprise selecting a power sourcing method that is capable of sourcing power from the external system without interrupting and operation of the external system.

15. The smart home device of claim 13, wherein the operations further comprise selecting the power sourcing comprises using a test load on an output of a power converter in the smart home device.

16. The smart home device of claim 15, wherein selecting the power sourcing method further comprises measuring a voltage at an input of the power converter as the test load is increased.

17. The smart home device of claim 16, wherein selecting the power sourcing method further comprises estimating an impedance of the external system based on a rate at which the voltage at the input of the power converter drops per increase of the test load.

18. The smart home device of claim 17, wherein selecting the power sourcing method further comprises comparing the impedance to a threshold to select the power sourcing method.

19. The smart home device of claim 13, wherein the operations further comprise monitoring a voltage drop on a storage capacitor to determine whether the selection of the power sourcing method should be used.
